(19) United States
(12) Patent Application Publication
(10) Pub. No.: US 2024/0192776 A1
(43) Pub. Date: Jun. 13, 2024

(54) Method for Pre-Training and Stabilizing Ultrasonic Brain-Machine Surfaces

(71) Applicant: California Institute of Technology, Pasadena, CA (US)

(72) Inventors: Whitney S Griggs, Pasadena, CA (US); Sumner L Norman, Pasadena, CA (US); Richard A Andersen, Pasadena, CA (US); Mikhail G Shapiro, Pasadena, CA (US)

(73) Assignee: California Institute of Technology, Pasadena, CA (US)

(21) Appl. No.: 18/505,827

(22) Filed: Nov. 9, 2023

Related U.S. Application Data
(60) Provisional application No. 63/424,235, filed on Nov. 10, 2022.

(51) Int. Cl. G06F 3/01; G06T 7/00; G06T 7/30

(52) U.S. Cl. CPC G06F 3/015; G06T 7/0012; G06T 7/30; G06T 2207/10088; G06T 2207/30016

(57) ABSTRACT

An apparatus and method for a pre-trained brain machine interface based on brain state data is disclosed. An initial session of determining brain state data during performance of a task by a subject at a first time is conducted. The brain state data correlated with task performance are recorded. A pre-training set of the brain state data is assembled. A decoder module of the brain machine interface system is pre-trained via the pre-training set of the recorded brain state data to decode intentions of the subject correlated with brain state. A current session is conducted at a second time subsequent to the first time. The current session includes the decoder module accepting a brain state data input of the brain of the subject, decoding a brain state output from the brain state data input, and generating a control signal to perform the task based on the determined brain state output.

### PRIORITY CLAIM

This disclosure claims priority to and the benefit of U.S. Provisional Application No. 63/424,235, filed Nov. 10, 2022. The contents of that application in their entirety are hereby incorporated by reference.

### FEDERAL GOVERNMENT SUPPORT STATEMENT

The subject matter of this invention was made with government support under Grant Nos. EY032799 & NS123663 awarded by the National Institutes of Health. The government has certain rights in the invention.

### TECHNICAL FIELD

The present disclosure relates to brain machine-interfaces, and specifically to pre-training a neuroimaging brain-machine interface for a current session based on functional ultrasound imaging of brain regions from a previous session.

### BACKGROUND

The following description includes information that may be useful in understanding the present invention. It is not an admission that any of the information provided herein is prior art or relevant to the presently claimed invention, or that any publication specifically or implicitly referenced is prior art.

Brain machine-interface (BMI) technologies communicate directly with the brain and can improve the quality of life of millions of patients with brain disorders. Motor BMIs are among the most powerful examples of BMI technology. Ongoing clinical trials of such BMIs implant microelectrode arrays into motor regions of tetraplegic participants. Movement intentions are decoded from recorded neural signals into command signals to control a computer cursor or a robotic limb. Clinical neural prosthetic systems enable paralyzed human participants to control external devices by: (a) transforming brain signals recorded from implanted electrode arrays into neural features; and (b) decoding neural features to predict the intent of the participant. However, these systems fail to deliver the precision, speed, degrees-of-freedom, and robustness of control enjoyed by motor-intact individuals. To enhance the overall performance of the BMI systems and to extend the lifetime of the implants, newer approaches for recovering functional information of the brain are necessary.

Brain-machine interfaces (BMIs) translate complex brain signals into computer commands and are a promising method to restore the capabilities of patients with paralysis. State-of-the-art BMIs have already been proven to function in limited clinical trials. However, these current BMIs require invasive electrode arrays that are inserted into the brain. Device degradation limits the longevity of BMI systems that rely on the implanted electrodes to typically around 5 years. Further, the implants only sample from small regions of the superficial cortex. Their field of view is small, restricting the number, and type, of applications possible. These are some of the factors limiting adoption of current BMI technology to a broader patient population.

Further, BMI requires extensive training of a neural network in a controller to accurately interpret brain signals to translate into the respective state for control signals. The training requires time to measure brain signals and correlate the brain signals with the desired state and must be conducted for each session that a BMI is used.

Thus, the next generation of BMI technology requires increased service life, being less invasive, and being scalable to sense activity from large regions of the brain. Further BMI systems require more efficient training. Functional ultrasound neuroimaging is a recently developed technique that meets these criteria.

### SUMMARY

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

One example is a method of training a brain machine interface system includes conducting an initial session of sensing brain state data of a brain of a subject during performance of a task at a first time. The brain state data correlated with the performance of the task are recorded. A pre-training set of the brain state data correlated with the performance of the task by the subject are assembled. A decoder module of the brain machine interface system is pre-trained with the pre-training set of the recorded brain state data to decode intentions of the subject correlated with brain state. A current session is conducted at a second time subsequent to the first time. The current session includes the pre-trained decoder module accepting a brain state data input of the brain of the subject, decoding a brain state output from the brain state data input, and generating a control signal to perform the task based on the determined brain state output.

In another implementation of the disclosed example method, the brain state data input of the brain of the subject is obtained via a functional ultrasound transducer coupled to a scanner. In another implementation, the functional ultrasound transducer is positioned for the left posterior parietal cortex (PPC) of the brain. In another implementation, the example method further includes sensing brain state data of the brain of the subject during performance of the task during the current session. The example method includes recording the brain state data correlated with the performance of the task. The example method includes adding the brain state data correlated with the successful performance of the task by the subject to the pre-training set of recorded brain state data. In another implementation, the brain state output is a kinematics control. The example method further includes providing the control signal to an output interface. In another implementation, the output interface is a display and the control signal manipulates an object on a display. In another implementation, the control signal manipulates a mechanical actuator. In another implementation, the first time is between 1 and 900 days from the second time. In another implementation, the brain state data are taken from an imaging plane of the brain, and the pre-training includes aligning the brain state data of the pre-training data set to produce a pre-registration alignment image. In another implementation, the pre-training brain state data are images produced by functional magnetic resonance imaging of the brain of the subject. In another implementation, the brain state data input is one of a 2D image or a 3D image. In another implementation, the brain state data input is one of a sequence of images used to decode the brain state. In another implementation, the decoder module performs principal component (PCA) and linear discriminant analysis (LDA) to predict movement direction from the brain state data.

Another disclosed example is a system for training a brain machine interface (BMI). The system includes a training set generation system including a transducer coupled to a sensing system to sense brain state data of a brain of a subject during performance of a task at a first time. The system includes a storage device storing the brain state data correlated with the performance of the task as a pre-training set of the brain state data correlated with the performance of the task by the subject. A decoder module of the brain machine interface system is trained with the pre-training set of the recorded brain state data to decode intentions of the subject correlated with brain state. A scanner is operable to sense brain state data of the brain of the subject. A BMI is coupled to the scanner. The BMI is operable to conduct a current session at a second time subsequent to the first time. The BMI includes the decoder module accepting a brain state data input of the brain of the subject, decoding a brain state output from the brain state data input, and generating a control signal to perform the task based on the determined brain state output.

In another implementation of the disclosed example system, the scanner includes a functional ultrasound transducer. In another implementation, the functional ultrasound transducer is positioned for the left posterior parietal cortex (PPC) of the brain. In another implementation, the BMI is further operable to: record the brain state data of the brain of the subject correlated with the performance of the task; and add the brain state data correlated with the performance of the task by the subject to the pre-training set of recorded brain state data. In another implementation, the example system includes an output interface, where the brain state output is a kinematics control coupled to the output interface. In another implementation, the output interface is a display and wherein the control signal manipulates an object on a display. In another implementation, the example system includes a mechanical actuator coupled to the output interface, wherein the control signal manipulates the mechanical actuator. In another implementation, the first time is between 1 and 900 days from the second time. In another implementation, the brain state data are taken from an imaging plane of the brain. The pre-training includes aligning the brain state data of the pre-training data set to produce a pre-registration alignment image. In another implementation, the pre-training brain state data are images produced by functional magnetic resonance imaging of the brain of the subject. In another implementation, the brain state data input is one of a 2D image or a 3D image. In another implementation, the brain state data input is one of a sequence of images used to decode the brain state. In another implementation, the decoder module performs principal component (PCA) and linear discriminant analysis (LDA) to predict movement direction from the brain state data.

Another disclosed example is a non-transitory computer-readable medium having machine-readable instructions stored thereon, which when executed by a processor, cause the processor to record brain state data of a brain of a subject correlated with the performance of a task at a first time. The instructions cause the processor to assemble a pre-training set of the brain state data correlated with the performance of the task by the subject. The instructions cause the processor to pre-train a decoder module of the brain machine interface system via the pre-training set of the recorded brain state data to decode intentions of the subject correlated with brain state. The instructions cause the processor to conduct a current session at a second time subsequent to the first time, wherein the current session includes the coder module accepting a brain state data input of the brain of the subject, decoding a brain state output from the brain state data input, and generating a control signal to perform the task based on the determined brain state output.

Another disclosed example is a method of determining a brain state for generating a control signal. Brain state data from a brain of a subject is sensed via a sensor during a current session. The brain state data from the brain of the subject is decoded to determine a brain state output via a decoder trained from a pre-training data set from a pre-training set of images correlated with successful performance of a task by the subject at a previous session. A control signal is generated to perform the task based on the brain state output.

In another implementation of the disclosed example method, the brain state data input of the brain of the subject is obtained via a functional ultrasound transducer coupled to a scanner. In another implementation, the functional ultrasound transducer is positioned for the left posterior parietal cortex (PPC) of the brain. In another implementation, the example method includes recording the brain state data correlated with the performance of the task; and adding the brain state data correlated with the performance of the task by the subject to the pre-training set of recorded brain state data. In another implementation, the brain state output is a kinematics control. The method further includes providing the control signal to an output interface. In another implementation, the output interface is a display and the control signal manipulates an object on a display. In another implementation, the control signal manipulates a mechanical actuator. In another implementation, the previous session occurs between 1 and 900 days from the current session. In another implementation, the brain state data are taken from an imaging plane of the brain. The pre-training includes aligning the brain state data of the pre-training data set to produce a pre-registration alignment image. In another implementation, the pre-training brain state data are images produced by functional magnetic resonance imaging of the brain of the subject. In another implementation, the brain state data input is one of a 2D image or a 3D image. In another implementation, brain state data image input is one of a sequence of images used to decode the brain state. In another implementation, the decoder performs principal component (PCA) and linear discriminant analysis (LDA) to predict movement direction from the brain state data.

Another disclosed example is a brain interface system including a sensor brain state data from a brain of a subject during a current session. A decoder determines a brain state output from the sensed brain state data. The decoder is trained from a pre-training set of brain state data correlated with performance of a task by the subject at a previous session. A controller is coupled to the decoder to generate a control signal to actuate performance of the task.

In another implementation of the disclosed example system, the scanner includes a functional ultrasound transducer. In another implementation, the functional ultrasound transducer is positioned for the left posterior parietal cortex (PPC) of the brain. In another implementation, the controller further: records the brain state data correlated with the performance of the task; and adds the brain state data correlated with the performance of the task by the subject to the pre-training set of recorded brain state data. In another implementation, the system includes an output interface coupled to the controller. The brain state output is a kinematics control, and the control signal is provided to the output interface. In another implementation, the output interface is a display and wherein the control signal manipulates an object on a display. In another implementation, the example system includes a mechanical actuator coupled to the output interface and the control signal manipulates the mechanical actuator. In another implementation, the time between the training session and the current session is between 1 and 900 days. In another implementation, the brain state data are taken from an imaging plane of the brain. The pre-training includes aligning the brain state data of the pre-training data set to produce a pre-registration alignment image. In another implementation, the pre-training brain state data are images produced by functional magnetic resonance imaging of the brain of the subject. In another implementation, the brain state data input is one of a 2D image or a 3D image. In another implementation, the brain state data input is one of a sequence of images used to decode the brain state. In another implementation, the decoder module performs principal component (PCA) and linear discriminant analysis (LDA) to predict movement direction from the brain state data.

Another disclosed example is a non-transitory computer-readable medium having machine-readable instructions stored thereon, which when executed by a processor, cause the processor to sense brain state data from a brain of a subject via a sensor during a current session. The instructions cause the processor to decode the brain state data from the brain of the subject to determine a brain state output via a decoder trained from a pre-training data set trained from a pre-training set of brain state data correlated with performance of a task by the subject at a previous session. The instructions cause the processor to generate a control signal to perform the task based on the brain state output.

### BRIEF DESCRIPTION OF DRAWINGS

In order to describe the manner in which the above-recited disclosure and its advantages and features can be obtained, a more particular description of the principles described above will be rendered by reference to specific examples illustrated in the appended drawings. These drawings depict only example aspects of the disclosure, and are therefore not to be considered as limiting of its scope. These principles are described and explained with additional specificity and detail through the use of the following drawings:

FIG. 1 shows an example brain machine interface system using an ultrasound implant, a trained decoder, and a control system for moving a cursor on a display;

FIG. 2A is a hardware diagram of an example test system used in conducting tests relating to the example trained BMI;

FIG. 2B is a perspective view of an ultrasonic transducer in the example test system in FIG. 2A;

FIG. 2C is a cross section of the ultrasonic transducer in the example test system in FIG. 2A;

FIG. 2D is a block diagram of the software components of the test system in FIG. 2A;

FIG. 3A is a set of images of brains of non-human primate test subjects taken from the test system in FIG. 2A;

FIG. 3B is a block diagram of a test for the example system in FIG. 2A that included memory guided saccade tasks;

FIG. 3C is a block diagram showing process of the collection of test data by the test system in FIG. 2A;

FIG. 3D is a block diagram of a test for the example system in FIG. 2A that included memory guided BMI tasks;

FIG. 3E is a diagram showing the test process for the memory-guided BMI task;

FIG. 4A is a set of results from a test using a two direction memory guided saccade task with no pretraining of the BMI decoder;

FIG. 4B is a set of results from a test using a two direction memory guided saccade task with pretraining of the BMI decoder;

FIG. 4C is a set of graphs showing the accuracy of the example BMI decoder with and without pretraining in the two direction memory guided saccade task;

FIG. 5A is a set of results from a test using an eight direction memory guided saccade task with no pretraining;

FIG. 5B is a set of results from a test using an eight direction memory guided saccade task with pretraining of the BMI decoder;

FIG. 5C is a set of graphs showing the accuracy of the example BMI decoder with and without pretraining in the eight direction memory guided saccade task;

FIG. 6 is a block diagram showing the process of a test involving a reach task;

FIG. 7A is a set of results from a test using a reach task with no pretraining of the BMI decoder;

FIG. 7B is a set of results from a test using the reach task with pretraining of the BMI decoder;

FIG. 7C is a set of graphs showing the accuracy of the example BMI decoder with and without pretraining of the BMI decoder in the reach task;

FIG. 8 is a set of images showing the process of aligning images from a pre-training session to produce an alignment image;

FIG. 9A are a set of confusion matrices for test subjects performing the eight direction memory guided saccade task over sessions conducted over a long period of time;

FIG. 9B are a set of graphs showing decoder stability for training and sessions for test subjects performing the eight direction memory guided saccade task over sessions conducted over a long period of time;

FIG. 9C is a set of graphs for the test subjects plotting mean angular error as a function of days between the training and testing session;

FIG. 10A shows images of vascular anatomy for test subjects over different test sessions over a relatively long time period;

FIG. 10B shows charts of pair-wise similarity between different vascular images for the test subjects; and

FIG. 10C shows graphs of performance as a function of image similarity for the test subjects.

### DETAILED DESCRIPTION

Unless defined otherwise, technical and scientific terms used herein have the same meaning as commonly understood by one of ordinary skill in the art to which this invention belongs. One skilled in the art will recognize many methods and materials similar or equivalent to those described herein, which could be used in the practice of the present invention. Indeed, the present invention is in no way limited to the methods and materials specifically described.

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations may be depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The present disclosure relates to a method and system for pretraining and/or stabilizing a neuroimaging-based brain-machine interface (BMI) using both new and previously collected brain state data such as image data from a brain during processing of commands. Pretraining based on the previously collected brain state input data from a brain during processing of commands reduces the need for calibrating the BMI and shortens the required training time. Stabilization helps maintain performance both within and across sessions, i.e., across time (hours, days, weeks, months, etc.). The example method and system also incorporates functional ultrasound neuroimaging. Thus, the example system assists in increasing service life of the BMI system, decreases invasiveness, and allows a wide range of data collection.

The example method consists of using image registration to align one, or multiple neuroimaging datasets to a common imaging field of view. In the pretraining scenario, the example method relies on co-registering neural populations (identified by imaging) and subsequently training a statistical model using the co-registered data from past sessions. For BMI stabilization, the example method regularly updates the co-registration to compensate for movement and/or changes in the recording field of view. This maintains and improves performance over time as additional data sets are incorporated into the training data set.

The example method also enables pretraining/stabilization between recording modalities. For example, a statistical model may be trained using data recorded by functional magnetic resonance imaging (fMRI). The resulting model may be used to decode intended behavioral signals from images such as those taken from functional ultrasound (fUS) neuroimaging data that is obtained from the brain of the subject.

The example BMI pre-training and stabilization method using live and pre-recorded 2D fUS neuroimaging data was successfully tested on a non-human primate performing various visual/motor behavioral tasks. The example method can be extended to novel BMI applications and across many modalities that produce neuro-functional images (such as 3D images, fUS images, MRI images, etc.) and non-image functional data, e.g., raw channel data.

Functional ultrasound (fUS) imaging is a recently developed technique that is poised to enable longer lasting, less invasive BMIs that can scale to sense activity from large regions of the brain. fUS neuroimaging is a means to collect brain state data that uses ultrafast pulse-echo imaging to sense changes in cerebral blood volume (CBV). fUS neuroimaging has a high sensitivity to slow blood flow (˜1 mm/s velocity) and balances good spatiotemporal resolution (100 μm; <1 sec) with a large and deep field of view (˜7 centimeters).

fUS neuroimaging possesses the sensitivity and field of view to decode movement intention on a single-trial basis simultaneously for two directions (left/right), two effectors (hand/eye), and task state (go/no-go). In this example, the fUS is incorporated into an online, closed-loop, functional ultrasound brain-machine interface (fUS-BMI). The example system allows decoding two or eight movement directions. The example decoder is stable across long periods of time after the initial training session.

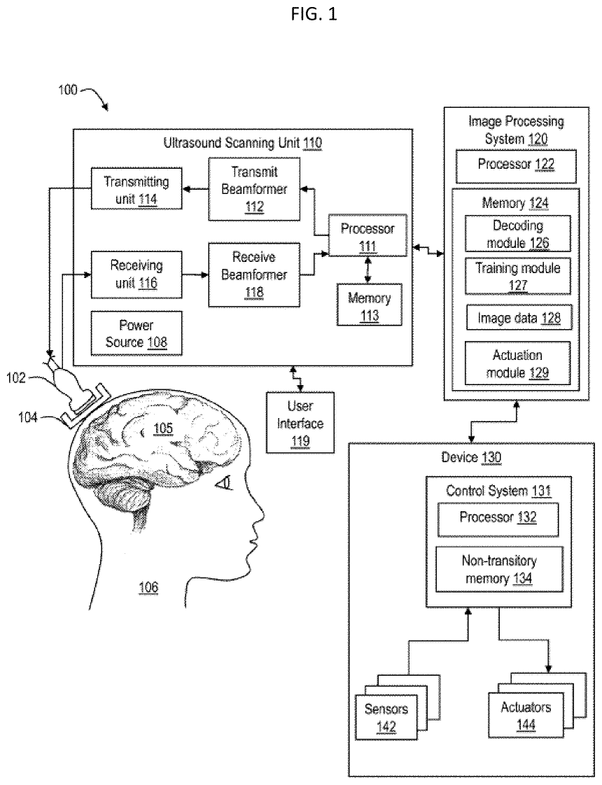

FIG. 1 illustrates a high-level block diagram of an example neural brain machine interface (BMI) system 100. The neural interface system 100 is configured to interface with the brain of a subject 106, perform, in real-time or near real-time, neuroimaging of the brain, and process, in real-time or near real-time, the neuroimaging data to determine one or more movement intentions of the subject 106. Further, the neural interface system 100 is configured to generate one or more control signals, in real time or near real-time, to a device 130 based on the one or more movement intentions determined from the neuroimaging data. The one or more movement intentions correspond to a cognitive state where a subject forms and develops motor planning activity before imagining, attempting, or executing a desired movement. As a non-limiting example, responsive to determining a movement intention of moving a desired effector (e.g., right arm) towards a desired direction (e.g., right), the neural interface system 100 may generate a control signal which may cause a corresponding prosthetic arm (e.g., right prosthetic arm) to move towards the desired direction (that is, right in this example) at the desired time. The desired effectors may be body effectors, including, but not limited to eyes, hands, arms, feet, legs, trunk, head, larynx, and tongue.

The neural interface system 100 comprises an ultrasound scanner or probe 102 for acquiring brain state data such as functional ultrasound (fUS) imaging of the brain, in real-time or near real-time. In particular, the ultrasound probe 102 may perform hemodynamic imaging of the brain to visualize changes in cerebral blood volume (CBV) using ultrafast Doppler angiography. fUS imaging enables a large field of view, and as such, a large area of the brain may be imaged using a single ultrasound probe. An example field of view of the ultrasound probe 102 may include various areas of posterior parietal cortex (PPC) of the brain including but not limited to lateral intraparietal (LIP) area, medial intraparietal (MIP) area, medial parietal area (MP), and ventral intraparietal (VIP) area.

Additionally or alternatively, fUS may be used to image hemodynamics in sensorimotor cortical areas and/or subcortical areas of the brain. For example, due to the large field of view of fUS systems, cortical areas deep within sulci and subcortical brain structures may be imaged in a minimally invasive manner that are otherwise inaccessible by electrodes. Further, fUS may be used to image hemodynamics in one or more of primary motor (M1), supplementary motor area (SMA), and premotor (PM) cortex of the brain.

In some examples, depending on a field of view of the ultrasound sound probe, larger or smaller areas of the brain may be imaged. Accordingly, in some examples more than one probe may be utilized for imaging various areas of the brain. However, in some examples, a single probe may be sufficient for imaging desired areas of the brain. As such, a number of probes utilized may vary and may be based at least on a desired imaging area, size of skull, and field of view of the probes. In this way, by using fUS, neural activity can be visualized not only larger areas of brain but also in deeper areas of brain with improved spatial and temporal resolution and sensitivity.

In one example, the probe 102 may be positioned within a chamber 104 coupled to the subject's skull. For example, a cranial window may be surgically opened while maintaining a dura underneath the cranium intact. The probe 102 and the chamber 104 may be positioned over the cranial window to enable neuroimaging via the cranial window. In some examples, an acoustic coupling gel may be utilized to place the probe 102 in contact with the dura mater above the brain 105 within the chamber 104.

In another example, a neuroplastic cranial implant that replaces a portion of a subject's skull may be used. The neuroplastic cranial implant may comprise one or more miniaturized probes, for example. Implanted probes may also perform data processing and/or decoding in addition to transmitting data and/or power wirelessly through the scalp to a receiver.

In another example, a sonolucent material is used to replace a portion of a subject's skull (cranioplasty) above a brain region of interest. One or more ultrasound probes can be positioned afterward above the scalp, implant, and brain region of interest in a non-invasive way, for example, via a cranial cap comprising a stereotaxic frame supporting one or more ultrasound probes. In yet another example, the one or more probes may be positioned above the scalp and skull without a craniotomy, for example, via a cranial cap comprising a stereotaxic frame supporting one or more ultrasound probes.

Further, the ultrasound probe 102 and its associated skull coupling portions (e.g., chamber 104, neuroplastic implants, stereotaxic frames, etc.) may be adapted for various skull shapes and sizes (e.g., adults, infants, etc.). Furthermore, the ultrasound probe 102 and the associated skull coupling portions may enable imaging of the brain while the subject is awake and/or moving. Further, in one example, the probe 102 may be placed surface normal to the brain on top of the skull in order to acquire images from the posterior parietal cortex of the brain for movement decoding. However, in order to image a larger area of the brain or multiple brain areas, additional probes, each positioned at any desired angle with respect to the brain may be utilized.

The neural interface system 100 further includes an ultrasound scanning unit 110 (hereinafter “scanning unit 110” or “scanner 110”) communicatively coupled to the ultrasound probe 102, and a real-time signal analysis and decoding system 120 communicatively coupled to the ultrasound scanning unit 110. Communication between the probe 102 and the scanning unit 110 may be wired, or wireless, or a combination thereof. Similarly, communication between the scanning unit 110 and the real-time signal analysis and decoding system 120 may be wired, or wireless, or a combination thereof. While the present example shows the scanning unit 110 and the real-time signal analysis and decoding system 120 separately, in some examples, the scanning unit 110 and the real-time signal analysis and decoding system 120 may be configured as a single unit. Thus, the ultrasound images acquired via the probe 102 may be processed by an integrated/embedded processor of the ultrasound scanner 110. In some examples, the real-time signal analysis and decoding system 120 and the scanning unit 110 may be separate but located within a common room. In some examples, the real-time signal analysis and decoding system 120 may be located in a remote location from the scanning unit 110. For example, the real-time signal analysis and decoding system may operate in a cloud-based server that has a distinct and remote location with respect to other components of the system 100, such as the probe 102 and scanning unit 110. Optionally, the scanning unit 110 and the real-time signal analysis and decoding system 120 may be a unitary system that is capable of being moved (e.g., portably) from room to room. For example, the unitary system may include wheels or be transported on a cart. Further, in some examples, the probe 102 may include an integrated scanning unit and/or an integrated real-time signal analysis and decoding system, and as such, fUS signal processing and decoding may be performed via the probe 102, and the decoded signals may be transmitted (e.g., wirelessly and/or wired) directly to the device 130.

In this example, the neural interface system 100 includes a transmit beamformer 112 and transmitting unit 114 that drives an array of transducer elements (not shown) of the probe 102. The transducer elements may comprise piezoelectric crystals (or semiconductor based transducer elements) within probe 102 to emit pulsed ultrasonic signals into the brain 105 of the subject. In one example, the probe 102 may be a linear array probe, and may include a linear array of a number of transducer elements. The number of transducer elements may be 128, 256, or another number suitable for ultrasound imaging of the brain. Further, in some examples, the probe may be a phased array probe. Furthermore, any type of probe that may be configured to generate plane waves may be used.

Ultrasonic pulses emitted by the transducer elements are back-scattered from structures in the body, for example, blood vessels and surrounding tissue, to produce echoes that return to the transducer elements. In one example, a conventional ultrasound imaging with focused beam may be performed. The echoes are received by a receiving unit 116. The received echoes are provided to a receive beamformer 118 that performs beamforming and outputs an RF signal. The RF signal is then provided to the processor 111 that processes the RF signal. Alternatively, the processor 111 may include a complex demodulator (not shown) that demodulates the RF signal to form IQ data pairs representative of the echo signals. In some examples, the RF or IQ signal data may then be provided directly to a memory 114 for storage (for example, temporary storage).

In order to detect CBV changes in the brain, Doppler ultrasound imaging may be performed. Doppler ultrasound imaging detects movement of red blood cells by repeating ultrasonic pulses and evaluating temporal variations of successive backscattered signals. In one embodiment, ultrafast ultrasound imaging may be utilized based on plane wave emission for imaging CBV changes in brain tissue. Plane wave emission involves simultaneously exciting all transducer elements of the probe 102 to generate a plane wave. Accordingly, the ultrafast ultrasound imaging includes emitting a set of plane waves at titled angles in a desired range from a start degree to a final degree tilt of the probe 102 at a desired angular increment (e.g., 1 degree, 2 degrees, 3 degrees, etc.). An example desired range may be from −15 degrees to 15 degrees. In some examples, the desired range may be from approximately −30 degrees to +30 degrees. The above examples of ranges are for illustration, and any desired range may be implemented based on one or more of area, depth, and imaging system configurations. In some examples, an expected cerebral blood flow velocity may be considered in determining the desired range for imaging.

In one non-limiting example, the set of plane waves may be emitted at tilted angles of −6 to 6° at 3 degree increments. In another non-limiting example, the set of plane waves may be emitted at tilted angles from −7° to 8° at 1-degree increments.

Further, in some examples, a 3-dimensional (3D) fUS sequence may be utilized for imaging one or more desired areas of the brain. In one example, in order to acquire 3D fUS sequences, a 4-axis motorized stage including at least one translation along the x, y, and/or z axes, and one rotation about the z axis may be utilized. For example, a plurality of linear scans may be performed while moving the probe to successive planes to perform a fUS acquisition at each position to generate 3D imaging data. In another example, in order to acquire 3D fUS sequences, a 2D matrix array or row-column array probe may be utilized to acquire 3D imaging data in a synchronous manner, i.e., without moving the probe. 3D imaging data thus obtained may be processed for evaluating hemodynamic activity in the targeted areas of the brain and decoding movement intentions may be decoded. Thus, the systems and methods described herein for movement intention decoding using fUS may also be implemented by using 3D fUS imaging data without departing from the scope of the disclosure.

Imaging data from each angle is collected via the receiving unit 116. The backscattered signals from every point of the imaging plane are collected and provided to a receive beamformer 118 that performs a parallel beamforming procedure to output a corresponding RF signal. The RF signal may then be utilized by the processor 111 to generate corresponding ultrasonic image frames for each plane wave emission. Thus, a plurality of ultrasonic images may be obtained from the set of plane wave emissions. A total number of the plurality of ultrasonic images is based on acquisition time, a total number of angles, and pulse repetition frequency.

The plurality of ultrasonic images obtained from the set of plane wave emissions may then be added coherently to generate a high-contrast compound image. In one example, coherent compounding includes performing a virtual synthetic refocusing by combining the backscattered echoes of the set of plane wave emissions. Alternatively, the complex demodulator (not shown) may demodulate the RF signal to form IQ data representative of the echo signals. A set of IQ demodulated images may be obtained from the IQ data. The set of IQ demodulated may then be coherently summed to generate the high-contrast compound image. In some examples, the RF or IQ signal data may then be provided to the memory 113 for storage (for example, temporary storage).

Further, in order to image brain areas with desired spatial resolution, the probe 102 may be configured to transmit high-frequency ultrasonic emissions. For example, the ultrasound probe may have a central frequency of at least 5 MHz for fUS imaging for single-trial decoding. Functional hyperemia (that is, changes in cerebral blood flow or volume corresponding to cognitive function) arises predominantly in microvasculature (sub-millimeter), and as such high-frequency ultrasonic emissions are utilized to improve spatial resolution to detect such signals. Further, as fUS enables brain tissue imaging at greater depths, movement intention decoding can be efficiently accomplished without invasive surgery that may be needed for an electrophysiology based BMI.

The processor 111 is configured to control operation of the neural interface system 100. For example, the processor 111 may include an image-processing module that receives image data (e.g., ultrasound signals in the form of RF signal data or IQ data pairs) and processes image data. For example, the image-processing module may process the ultrasound signals to generate volumes or frames of ultrasound information (e.g., ultrasound images) for display to the operator. In system 100, the image-processing module may be configured to perform one or more processing operations according to a plurality of selectable ultrasound modalities on the acquired ultrasound information. By way of example only, the ultrasound modalities may include color-flow, acoustic radiation force imaging (ARFI), B-mode, A-mode, M-mode, spectral Doppler, acoustic streaming, tissue Doppler module, C-scan, and elastography. The generated ultrasound images may be two-dimensional (2D) or three-dimensional (3D). When multiple two-dimensional (2D) images are obtained, the image-processing module may also be configured to stabilize or register the images.

Further, acquired ultrasound information may be processed in real-time or near real-time during an imaging session (or scanning session) as the echo signals are received. In some examples, an image memory may be included for storing processed slices of acquired ultrasound information that may be accessed at a later time. The image memory may comprise any known data storage medium, for example, a permanent storage medium, removable storage medium, and the like. Additionally, the image memory may be a non-transitory storage medium.

In operation, an ultrasound system may acquire data, for example, volumetric data sets by various techniques (for example, 3D scanning, real-time 3D imaging, volume scanning, 2D scanning with probes having positioning sensors, scanning using 2D or matrix array probes, and the like). In some examples, the ultrasound images of the neural interface system 100 may be generated, via the processor 111, from the acquired data, and displayed to an operator or user a display device of a user interface 119 communicatively coupled to the scanning unit 110.

In some examples, the processor 111 is operably connected to the user interface 119 that enables an operator to control at least some of the operations of the system 100. The user interface 119 may include hardware, firmware, software, or a combination thereof that enables a user (e.g., an operator) to directly or indirectly control operation of the system 100 and the various components thereof. The user interface 119 may include a display device (not shown) having a display area (not shown). In some embodiments, the user interface 119 may also include one or more input devices (not shown), such as a physical keyboard, mouse, and/or touchpad. In an exemplary embodiment, the display device 118 is a touch-sensitive display (e.g., touchscreen) that can detect a presence of a touch from the operator on the display area and can also identify a location of the touch in the display area. The display device also communicates information from the processor 111 to the operator by displaying the information to the operator. The display device 118 may be configured to present information to the operator during one or more of an imaging session, and training session. The information presented may include ultrasound images, graphical elements, and user-selectable elements, for example.

The neural interface system 100 further includes the real-time signal analysis and decoding system 120 which may be utilized for decoding neural activity in real-time. In one example, neural activity may be determined based on hemodynamic changes, which can be visualized via fUS imaging. As discussed above, while the real-time signal analysis and decoding system 120 and the scanning unit 110 are shown separately, in some embodiments, the real-time signal analysis and decoding system 120 may be integrated within the scanning unit and/or the operations of the real-time signal analysis and decoding system 120 may be performed by the processor 111 and memory 113 of the scanning unit 110.

The real-time signal analysis and decoding system 120 is communicatively coupled to the ultrasound scanning unit 110, and receives ultrasound data from the scanning unit 110. In one example, the real-time signal analysis and decoding system 120 receives compounded ultrasound images, in real-time or near real-time, generated via the processor 111 based on plane wave emission via probe 102. The real-time signal analysis and decoding system 120 includes non-transitory memory 113 that stores a decoding module 126. The decoding module 126 may include a decoding model that is trained for decoding movement intentions of a subject by correlating neural activity in the brain using the compounded ultrasound images received from the scanning unit 110 with movement intention. The decoding model may be a machine learning model that is pre-trained with data from previous sessions with the subject as will be explained herein. Accordingly, the decoding module 126 may include instructions for receiving imaging data acquired via an ultrasound probe, and implementing the decoding model for determining one or more movement intentions of a subject. In one example, the imaging data may include a plurality of CBV images generated by a performing power Doppler imaging sequence via an ultrasound probe 102. In one example, the CBV images are compound ultrasound images generated based on Doppler imaging of the brain.

Non-transitory memory 124 may further store a training module 127, which includes instructions for training the machine learning model stored in the decoding module 108. Training module 127 may include instructions that, when executed by processor 122, cause real-time signal analysis and decoding system 120 to train the decoding model that has been pre-trained using a training dataset that may include imaging datasets from previous training sessions as will be described below. Example protocols implemented by the training module 110 may include learning techniques such as gradient descent algorithm, such that the decoding model can be trained and can classify input data that were not used for training.

Non-transitory memory 124 may also store an inference module (not depicted) that comprises instructions for testing new data with the trained decoding model. Further, non-transitory memory 124 may store image data 128 received from the ultrasound scanning unit 110. In some examples, the image data 128 may include a plurality of training datasets generated via the ultrasound scanning unit 110.

Real-time signal analysis and decoding system 120 may further include a user interface (not shown). The user interface may be a user input device, and may comprise one or more of a touchscreen, a keyboard, a mouse, a trackpad, a motion sensing camera, an eye tracking camera, and other device configured to enable a user to interact with and manipulate data within the processing system 120.

The real-time signal analysis and decoding system 120 may further include an actuation module 129 for generating one or more actuation signals in real-time based on one or more decoded movement intention (e.g., determined via the decoding model). In one example, the actuation module 129 may use a derived transformation rule to map an intended movement signal, s, into an action, a, for example, a target. Statistical decision theory may be used to derive the transformation rule. Factors in the derivations may include the set of possible intended movement signals, S, and the set of possible actions, A. The neuro-motor transform, d, is a mapping for S to A. Other factors in the derivation may include an intended target θ and a loss function which represents the error associated with taking an action, a, when the true intention was θ. These variables may be stored in a memory device, e.g., memory 124.

In some examples, two approaches may be used to derive the transformation rule: a probabilistic approach, involving the intermediate step of evaluating a probabilistic relation between s and 0 and subsequent minimization of an expected loss to obtain a neuro-motor transformation (i.e., in those embodiments of the invention that relate to intended movement rather than, e.g., emotion); and a direct approach, involving direct construction of a neuro-motor transformation and minimizing the empirical loss evaluated over the training set. Once the actuation module maps an intended movement signal to an action, the actuation module 129 may generate an actuation signal indicative of the cognitive signal (that is, intended movement signal) and transmit the actuation signal to a device control system 131 of a device 130. The device control system 131 may use the actuation signal to adjust operation of one or more actuators 144, that may be configured to execute a movement based on the actuation signals generated by the actuation module 129. For example, adjusting the operation of one or more actuators 144 may include mimicking the subject's intended movement or perform another task (e.g., move a cursor, turn off the lights, perform home environmental temperature control adjustments) associated with the cognitive signal.

Thus, based on decoded intended movements, via the decoding module 126, one or more actuation signals may be transmitted to the device 130 communicatively coupled to the neural interface system 100. Further, the control system 131 is configured to receive signals from and send signals to the real-time signal analysis and decoding system 120 via a network. The network may be wired, wireless, or various combinations of wired and wireless. In some examples, the actuation module 129 may be configured as a part of the device 130. Accordingly, in some examples, the device 130 may generate one or more actuation signals based on movement intention signals generated by an integrated decoding module. As a non-limiting example, based on a movement intention (e.g., move right hand to the right), the actuation module 129 may generate, in real-time, an actuation signal which is transmitted, in real-time, to the control system 131. The actuation signal may then be processed by the device control system 131 and transmitted to a corresponding actuator (e.g., a motor actuator of a right hand prosthetic limb) causing the actuator to execute the intended movement.

The device 130 may be, for example, a robotic prosthetic, a robotic orthotic, a computing device, a speech prosthetic or speller device, or a functional electrical stimulation device implanted into the subject's muscles for direct stimulation and control or any assistive device. In some examples, the device 130 may be a smart home device, and the actuation signal may be transmitted to the smart home controller to adjust operation of the smart home device (e.g., a smart home thermostat, a smart home light, etc.) without the need for using a prosthetic limb. Thus, the neural interface system 100 may interface with a control system of a device, without the use of a prosthetic limb. In some examples, the device may be a vehicle and the actuation signal may be transmitted to a vehicle controller to adjust operation of the vehicle (e.g., to lock/unlock door, to open/close door, etc.). Indeed, there are a wide range of tasks that can be controlled by a prosthetic that receives instruction based on the cognitive signals harnessed in various embodiments of the present disclosure. Reaches with a prosthetic limb could be readily accomplished. An object such as a cursor may be moved on a screen to control a computer device. Alternatively, the mental/emotional state of a subject (e.g., for paralyzed patients) may be assessed, as can intended value (e.g., thinking about a pencil to cause a computer program (e.g., Visio) to switch to a pencil tool, etc.). Other external devices that may be instructed with such signals, in accordance with alternate embodiments of the present disclosure, include, without limitation, a wheelchair or vehicle; a controller, such as a touch pad, keyboard, or combinations of the same; and a robotic hand.

In some examples, the neural interface system 100 may be communicatively coupled one or more devices. Accordingly, the neural interface system 100 may transmit control signals (based on decoded intention signals) simultaneously or sequentially to more than one device communicatively coupled to the neural interface system 100. For example, responsive to decoding movement intentions, the real-time signal analysis and decoding system 120 may generate and transmit a first control signal (e.g., based on decoding a first intended effector, such as arms, first direction, and/or first action) to a first device (e.g. robotic limb to grasp a cup) and simultaneously or sequentially, generate and transmit a second control signal (e.g., based on a second decoded intended effector such as eyes, second direction, and/or second action) to a second device (e.g., computer for cursor movement). Thus, in some examples, the neural interface system 100 may be configured to communicate with and/or adjust operation of more than one device.

The actuation module 129 may use a feedback controller to monitor the response of the device, via one or more sensors 142, and compare it to, e.g., a predicted intended movement, and adjust actuation signals accordingly. For example, the feedback controller may include a training program to update a loss function variable used by the actuation module 129.

The subject may be required to perform multiple trials to build a database for the desired hemodynamic signals corresponding to a particular task. As the subject performs a trial, e.g., a reach task or brain control task, the neural data may be added to a database for pre-training of the decoder for a current session. The memory data may be decoded, e.g., using a trained decoding model, and used to control the prosthetic to perform a task corresponding to the cognitive signal. Other predictive models may alternatively be used to predict the intended movement or other cognitive instruction encoded by the neural signals.

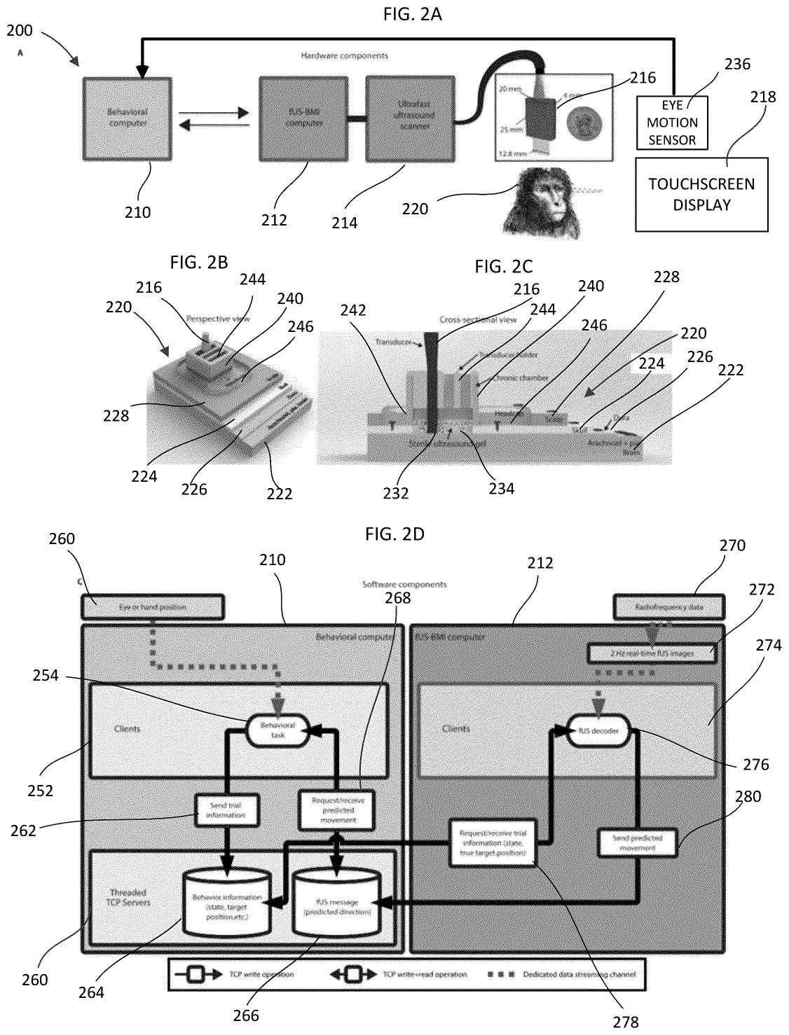

FIG. 2A shows a hardware block diagram of a test system 200 that was used to establish the effectiveness of the example BMI pre-training method. The test system 200 includes a behavioral computer system 210, a functional ultrasound (fUS) BMI computer 212, an ultra-fast ultrasound scanner 214, and an ultrasonic transducer 216. In the example test system 200, the transducer 216 is a 128-element miniaturized linear array probe, 15.6 MHz center frequency, 0.1 mm pitch available from Vermon of Tours, France that is paired with a real-time ultrafast ultrasound acquisition system of the scanner 214 to stream 2 Hz fUS images. Testing was performed using the system on two nonhuman primates (NHPs) as they performed memory-guided eye movements.

FIG. 2B shows a perspective view of the ultrasonic transducer 216 attached to the head of a test subject 220. FIG. 2C a cross section of the ultrasonic transducer 216 attached to the head of the test subject 220. The test subject 220 has a brain 222 protected by a skull 224. A dura layer 226 insulates the skull 224 from the brain 222. The skull 224 is covered by a scalp 228.

The transducer 216 includes a transducing surface 232 that is inserted in a sterile ultrasound gel layer 234 applied to the brain 222. A rectangular chronic chamber 240 is inserted through an aperture 242 created in the skull 224. The rectangular chronic chamber 240 is attached to a transducer holder 244 that holds the transducer 216. The chronic chamber 240 is attached to a headcap 246 that is inserted over the aperture 242 on the scalp 228. Thus, the chronic chamber 240 and holder 244 hold the transducer 216 such that the sensing end 232 is in contact with the brain 222.

In the tests, the transducer surface 232 was positioned normal to the brain 222 above the dura mater 226 and recorded from coronal planes of the left posterior parietal cortex (PPC), a sensorimotor association area that uses multisensory information to guide movements and attention. This technique achieved a large field of view (12.8 mm width, 16 mm depth, 400 μm plane thickness) while maintaining high spatial resolution (100 μm×100 μm in-plane). This allowed streaming high-resolution hemodynamic changes across multiple PPC regions simultaneously, including the lateral (LIP) and medial (MIP) intraparietal cortex. Previous research has shown that the LIP and MIP are involved in planning eye and reach movements respectively. This makes the PPC a good region from which to record effector-specific movement signals. Thus, the sensing end 232 of the transducer 216 was positioned above the dura 226 with the ultrasound gel layer 234. The ultrasound transducer 216 was positioned in the recording sessions using the slotted chamber plug holder 244. The imaging field of view was 12.8 mm (width) by 13-20 mm (height) and allowed the simultaneous imaging of multiple cortical regions of the brain 222, including the lateral intraparietal area (LIP), the medial intraparietal area (MIP), the ventral intraparietal area (VIP), Area 7, and Area 5.

The tests employed Neuroscan software interfaced with MATLAB 2019b for the real-time fUS-BMI and MATLAB 2021a for all other analyses in the fUS-BMI computer 212. For each NHP test subject, a cranial implant containing a titanium head post was placed over the dorsal surface of the skull and a craniotomy positioned over the posterior parietal cortex of the brain 222. The dura 226 underneath the craniotomy was left intact. The craniotomy was covered by a 24×24 mm (inner dimension) chamber 240. For each recording session, the custom 3D-printed polyetherimide slotted chamber plug 240 that held the ultrasound transducer 216 was used. This transducer 216 allowed the same anatomical planes to be consistently acquired on different days.

As shown in FIG. 2A, the test subject 220 is positioned relative to a touchscreen display 218 that displays visual cues. In the behavioral setup, the NHP test subjects sat in a primate chair facing the monitor or touchscreen 218. The touchscreen monitor 218 was positioned approximately 30 cm in front of the NHP. The touchscreen was positioned on each day so that the NHP could reach all the targets on the display screen with his fingers but could not rest his palm on the screen. In this example, the display screen is an ELO IntelliTouch touchscreen display available from ELO Touch Solutions, Inc. of Milpitas, California.

An eye motion sensor 236 followed the eyes of the test subject 220 and generates eye position data that is sent to the behavioral computer system 210. Eye position is tracked at 500 Hz using the eye motion sensor 236, which was an infrared eye tracker such as an EyeLink 1000 available from SR Research Ltd. of Ottawa, Canada). Touch is tracked using the touchscreen display screen 218. Visual stimuli such as the cues were presented using custom Python 2.7 software based on PsychoPy. Eye and hand position was recorded simultaneously with the stimulus and timing information and stored for offline analysis.

The programmable high-framerate ultrasound scanner 214 is a Vantage 256 scanner available from Verasonics of Kirkland, WA. The scanner 214 was used to drive the ultrasound transducer 216 and collect pulse echo radio frequency data. Different plane-wave imaging sequences were used for real-time and anatomical fUS neuroimaging.

The real-time fUS neuroimaging performed by the computer 212 in this example is a custom-built computer running NeuroScan Live software available from ART INSERM U1273 & Iconeus of Paris, France attached to the 256-channel Verasonics Vantage ultrasound scanner 214. This software implemented a custom plane-wave imaging sequence optimized to run in real-time at 2 Hz with minimal latency between ultrasound pulses and Power Doppler image formation. The sequence used a pulse-repetition frequency of 5500 Hz and transmitted plane waves at 11 tilted angles. The tilted plane waves were compounded at 500 Hz. Power Doppler images were formed from 200 compounded B-mode images (400 ms). To form the Power Doppler images, the software used an ultrafast Power Doppler sequence with an SVD clutter filter that discarded the first 30% of components. The resulting Power Doppler images were transferred to a MATLAB instance in real-time and used by the fUS-BMI computer 212. The prototype 2 Hz real-time fUSI system had a 0.71±0.2 second (mean±STD) latency from ultrasound pulse to image formation. Each fUSI image and associated timing information were saved for post hoc analyses.

For anatomical fUS neuroimaging a custom plane-wave imaging sequence was used to acquire an anatomical image of the vasculature. A pulse repetition frequency of 7500 Hz and transmitted plane waves at 5 angles ([−6°, −3°, 0°, 3°, 6°]) with 3 accumulations was used. The 5 angles were coherently compounded from 3 accumulations (15 images) to create one high-contrast ultrasound image. Each high-contrast image was formed in 2 ms, i.e., at a 500 Hz framerate. A Power Doppler image of the brain of the NHP test subjects was formed using 250 compounded B-mode images collected over 500 ms. Singular value decomposition was used to implement a tissue clutter filter and separate blood cell motion from tissue motion.

FIG. 2D shows a block diagram of the software components of the test system 200. The software components are executed by the behavioral computer system 210 and the fUS BMI computer 212. A set of position inputs 250 that include either eye or hand position are fed into the behavioral computer system 210. In this example, the behavioral computer system 210 includes a client application 252 that is associated with a particular behavioral task 254. In this example, the behavioral task 254 may include tracking movement in two directions or eight directions, a reach task, or other tasks as explained herein. The behavioral computer system 210 also includes TCP threaded database servers 260. The threaded TCP server 260 was designed in Python 2.7 to receive, parse, and send information between the computer running the PsychoPy behavior software and the real-time fUS-BMI computer 212. Upon queries from the fUS-BMI computer 212, the server 260 transferred task information, including task timing and actual movement direction, to the real-time ultrasound system. The real-time ultrasound system includes the transducer 216 and the scanner 214. The client-server architecture is specifically designed to prevent data leaks, i.e., the actual movement direction is never transmitted to the fUS-BMI computer 212 until after a successful trial had ended. The average server write-read-parse time was 31+/−1 (mean±STD) ms during offline testing between the two desktop Windows computers 210 and 212 on a local area network (LAN).

Trial information data 262 was sent to a behavior information database 264 by the behavioral task 254. Previous predictions are stored in an ultrasonic image database 266. The behavioral task 254 requests and receives predicted movement data 268 from the database 266 to perform the behavioral task 254.

Radio frequency data 270 from the transducer 216 is input into the computer 212. The computer 212 breaks down the radio frequency data 270 into real-time functional ultrasound images 272. The computer 212 executes client applications 274 that includes a BMI decoder 276 that that converts the fUSI images into computer commands. The BMI decoder 276 requests and receives trial information 278 such as state and true target information from the behavior information database 264. After receiving the trial information, the BMI decoder 276 sends a predicted movement 280 to the fUS message database 266. Thus, the TCP server 260 also received the fUS-BMI prediction 280 and passed the prediction to the PsychoPy software of the decoder 276 when queried.

The real-time 2 Hz fUS images 272 are streamed into the BMI decoder 276 that uses principal component (PCA) and linear discriminant analysis (LDA) to predict planned movement directions. The BMI output is used to directly control the behavioral task of the respective tests.

There were three steps to decoding movement intention in real-time for the brain machine interface executed by the BMI computer 212 of the system 200: 1) applying preprocessing to a rolling data buffer; 2) training the classifier in the decoder 276; and 3) decoding movement intention in real-time using the trained classifier. The time for preprocessing, training, and decoding is dependent upon several factors, including the number of trials in the training set, CPU load from other applications, the field of view, and the classifier algorithm (PCA+LDA vs cPCA+LDA). In the worst cases during offline testing, the preprocessing, training, and decoder respectively took approximately 10, 500 ms, and 60 ms.

Before feeding the Power Doppler images into the classification algorithm, two preprocessing operations were applied to a rolling 60-frame (30 seconds) buffer. First, a rolling voxel-wise z-score was performed over the previous 60 frames (30 seconds). Second, a pillbox spatial filter was applied with a radius of 2 pixels to each of the 60 frames in the buffer.

The fUS-BMI computer 212 makes a prediction at the end of the memory period using the preceding 1.5 seconds of data (3 frames) and passes this prediction to the behavioral control system 254 via the threaded TCP-based server 260 in FIG. 2D. Different classification algorithms for fUS-BMI were used in the 2-direction and 8-direction tasks. For decoding two directions of eye or hand movements, a class wise principal component analysis (cPCA) and linear discriminant analysis (LDA) was used. This is a method well suited to classification problems with high dimensional features and low numbers of samples. This method is identical to that used previously for offline decoding of movement intention but has been optimized for online training and decoding. Briefly, the cPCA was used to dimensionally reduce the data while keeping 95% variance of the data. LDA was then used to improve the class separability of the cPCA-transformed data.

For decoding eight directions of eye movements, a multi-coder approach was used where the horizontal (left, center, or right) and vertical components (down, center, or up) were separately predicted and combined to form the final prediction. As a result of this separate decoding of horizontal and vertical movement components, “center” predictions are possible (horizontal—center and vertical—center) although this is not one of the eight peripheral target locations. To perform the predictions, principal component analysis (PCA) and LDA was used. The PCA was used to reduce the dimensionality of the data while keeping 95% of the variance in the data. The LDA was used to predict the most likely direction. The PCA+LDA method was selected over the cPCA+LDA for 8-direction decoding because in pilot offline data, the PCA+LDA multi-coder worked marginally better than the cPCA+LDA method for decoding eight movement directions with a limited number of training trials.

The tests were conducted on two healthy 14-year-old male rhesus macaque monkeys (Macaca mulatta) weighing 14-17 kg designated as NHP test subjects L and P. The test monkeys were implanted with the ultrasound transducers such as the transducer 216 in FIGS. 2B-2C. All surgical and animal care procedures were approved by the California Institute of Technology Institutional Animal Care and Use Committee and complied with the Public Health Service Policy on the Humane Care and Use of Laboratory Animals.

The NHP test subjects performed several different memory-guided movement tasks including the memory guided saccade tasks and the memory-guided reach task. In the memory-guided saccade tasks, the NHP test subjects fixated on a center cue for 5±1 seconds. A peripheral cue appeared for 400 ms in a peripheral location (either chosen from 2 or 8 possible target locations) at 20° eccentricity. The NHP subject kept fixation on the center cue through a memory period (5±1 s) where the peripheral cue was not visible. The NHP test subject then executed a saccade to the remembered location once the fixation cue was extinguished. If the eye position of the NHP test subject was within a 7° radius of the peripheral target, the target was re-illuminated and stayed on for the duration of the hold period (1.5±0.5 s). The NHP test subject received a liquid reward of 1000 ms (0.75 mL) for successful task completion. There was an 8±2 second intertrial interval before the next trial began. Fixation, memory, and hold periods were subject to timing jitter sampled from a uniform distribution to prevent the NHP test subject from anticipating task state changes.

The memory-guided reach task was similar to the memory guided saccade tasks, but instead of fixation, the NHP used fingers on a touchscreen. Due to space constraints, eye tracking was not used concurrently with the touchscreen, i.e., only hand or eye position was tracked, not both.

For the memory-guided BMI task, the NHP test subject performed the same fixation steps using his eye or hand position, but the movement phase was controlled by the fUS-BMI test system 200. Critically, the NHP was trained to not make an eye or hand movements from the center cue until at least the reward was delivered. For this task variant, the NHP received a liquid reward that was 1000 ms (0.75 mL) for successfully maintaining fixation/touch for correct fUS-BMI predictions and 100 ms (0.03 mL) for successfully maintaining fixation/touch for incorrect fUS-BMI predictions. This was done to maintain NHP motivation even if the fUS-BMI was inaccurate.

The fUS-BMI decoder was retrained during the inter-trial interval whenever the training set changed. For the real-time experiments, each successful trial was automatically added to the training set. In the training phase, successful trials were defined as the NHP test subject performing the movement to the correct target and receiving his juice reward. In the BMI mode, successful trials were defined as a correct prediction plus the NHP test subject maintaining fixation until juice delivery.

For experiments using data from a previous session, the model for the BMI decoder 276 was trained using all the valid trials in the training data set 374 from the previous session upon initialization of the fUSI-BMI. A valid trial was defined as any trial that reached the prediction phase, regardless of whether the correct class was predicted. The BMI decoder 276 was then retrained after each successful trial was added to the training set 370 during the current session.

For post hoc experiments analyzing the effect of using only data from a given session, all trials where the test subject monkey received a reward were considered as successful and retrained after each trial. This was done to keep the many training trials where the NHP test subject maintained fixation throughout the trial despite an incorrect BMI prediction.

At the beginning of each experimental session, a single anatomical fUS image was acquired from the transducer 216 using the beam forming process showing the macro- and mesovasculature within the imaging field of view. For sessions where previous data was used as the initial training set for the fUS-BMI, a semi-automated intensity-based rigid-body registration was performed between the new anatomical image and the anatomical image acquired in a previous session. The MATLAB “imregtform” function was used with the mean square error metric and a regular step gradient descent optimizer to generate an initial automated alignment of the previous anatomical image to the new anatomical image. If the automated alignment had misaligned the two images, the anatomical image from the previous session was manually shifted and rotated using a custom MATLAB GUI. The final rigid body was applied to transform the training data from the previous session, thus aligning the previous session to the new session.

Summary statistics were reported as XX±XX are mean±SEM.

The recorded real-time fUS images were used to simulate the effects of different parameters on fUS-BMI performance, such as using only current session data without pretraining. To do this, the recorded fUS images and behavioral data were fed frame by frame through the same fUS-BMI function used for the closed-loop, online fUS-BMI. To dynamically build the training set 374, all trials reaching the end of the memory phase were added to the training set 374 regardless of whether the offline fUS-BMI predicted the correct movement direction. This was done because the high possible error rate from bad predictions meant that building the training set from only correctly predicted trials could be imbalanced for the different directions and possibly contain insufficient trials to train the model, e.g., no correct predictions for certain directions would prevent the model from being able to predict that direction.

A circular region of interest (ROI; 200 μm radius) was defined and moved the circular region of interest sequentially across all voxels in the imaging field of view. For each ROI, offline decoding with 10-fold cross-validation was performed using either the cPCA+LDA (2-directions) or PCA+LDA (8-directions) algorithm. The voxels fully contained with each ROI were used in both algorithms. The mean performance across the cross-validation folds was assigned to the center voxel of the ROI. To visualize the results, the performance (mean absolute angular error or accuracy) of the 10% most significant voxels was overlaid on the anatomical vascular map from the session.

In the tests, the two NHP test subjects initially performed instructed eye movements to a randomized set of two or eight peripheral targets to build the initial training set for the decoder 276. The fUS activity during the delay period preceding successful eye movements were used to train the decoder 276. After 100 successful training trials, the system 200 was switched to a closed-loop BMI mode where the movement directions came from the fUS-BMI computer 212. During the closed-loop BMI mode, the NHP test subject continued to fixate on the center cue until after the delivery of the liquid reward. During the interval between a successful trial and the subsequent trial, the decoder 276 was rapidly retrained, continuously updating the decoder model as each NHP test subject used the fUS-BMI system.

A first set of tests was directed toward online decoding of two eye movement directions. To demonstrate the feasibility of an example fUS-BMI system, online, closed-loop decoding of two movement directions was performed. A second set of tests was directed toward online decoding of eight eye movement directions.

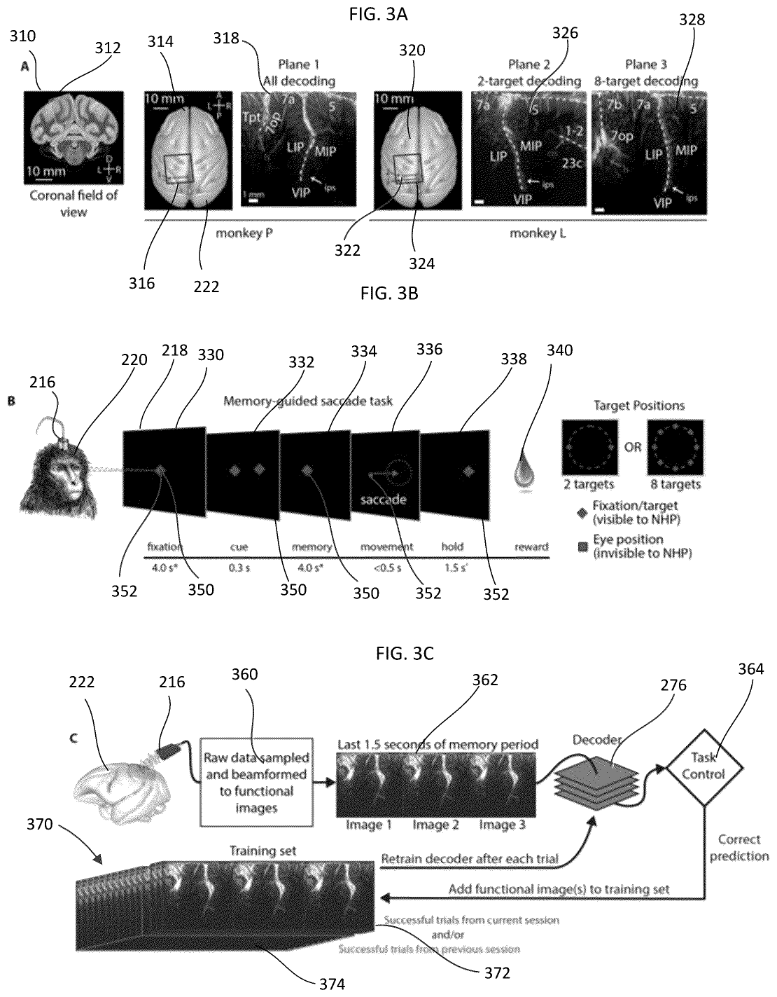

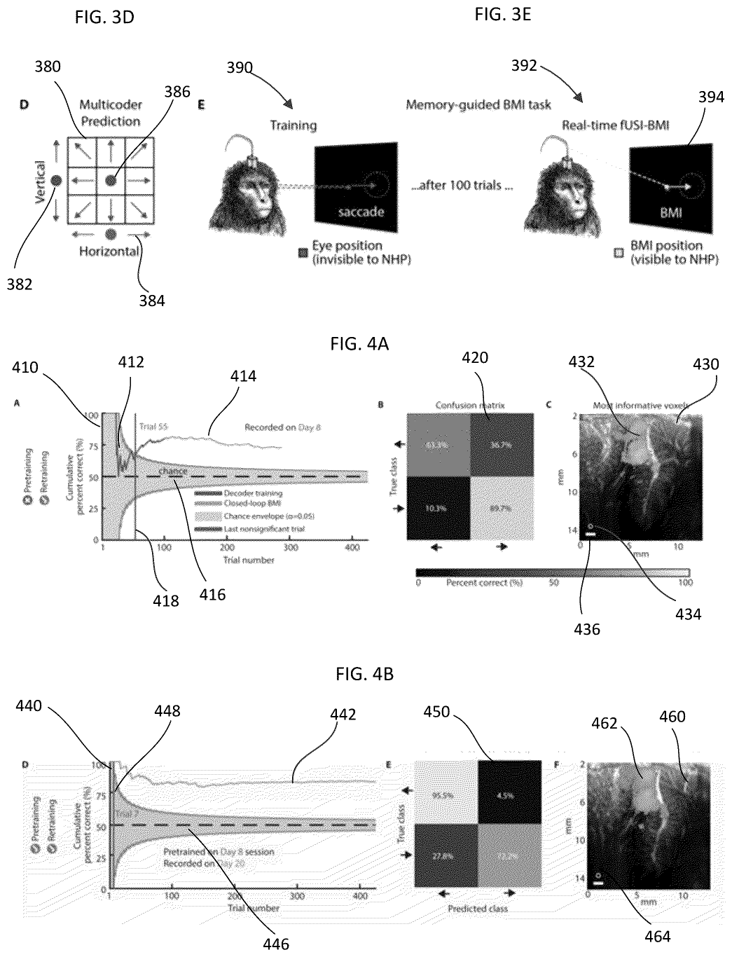

In the tests, coronal fUS imaging planes were used for the monkey P and the monkey L. A coronal slice from an MRI atlas showed the approximate field of view for the fUS imaging plane. 24×24 mm (inner dimension) chambers were placed surface normal to the skull of the test monkeys P and L above a craniotomy (black square). FIG. 3A shows a series of images that were acquired for the tests. A first image 310 shows a coronal field of view of the brain 222 superimposed on a coronal image from an MRI standardized monkey brain atlas. A box 312 shows the position of the transducing surface 232 of the transducer 216 for the tests. The other images in FIG. 3A are grouped for the NHP test subject P and the NHP test subject L. An image 314 shows a top down representation of the brain of the test subject monkey P. A line 316 represents the first plane that an ultrasound image was taken from the test subject monkey P. A functional ultrasound image 318 shows the first plane represented by the line 316 in the image 314.

An image 320 shows a top down representation of the brain of the test subject monkey L. A line 322 represents the second plane that an ultrasound image was taken from and a line 324 represents the third plane that an ultrasound image was taken from. An ultrasound image 326 was generated from the second plane in the two target task performed by the test subject monkey L. An ultrasound image 328 was generated from the third plane in the eight target task performed by the test subject monkey L.

The ultrasound transducer 216 was positioned to acquire a consistent coronal plane across different sessions as shown by the line 316 on the image 314 and the lines 322 and 324 for the other two planes in the images 326 and 328. The vascular maps in each of the images 318, 326, and 328 show the mean Power Doppler image from a single imaging session. The three imaging planes shown in images 318, 326, and 328 were chosen for good decoding performance in a pilot offline dataset. Anatomical labels were inserted in the images 318, 326 and 328.

FIG. 3B shows the process for the first tests that involve the memory-guided saccade task for two eye movement directions. The non-human primate (NHP) test subject 220 had the transducer 216 attached as explained above. A trial started with the NHP test subject 220 fixating on a center fixation cue on the display 218 (330). A target cue 350 was flashed in a peripheral location (312). The position of the eye of the NHP test subject as determined by the eye motion sensor 236 in FIG. 2A is represented by a box 352. During a memory period (314), the NHP test subject 220 continued to fixate on the center cue 350 and planned an eye movement to the peripheral target location. Once the fixation cue was extinguished, the NHP test subject 220 performed a saccade to the remembered location (316) and maintained fixation on the peripheral location (318) before receiving a liquid reward (320). The fixation, memory, and hold periods were subject to ±500 ms of jitter (uniform distribution) to prevent the NHP test subject from anticipating task state changes. The peripheral cue was chosen from two or eight possible target locations depending on the specific experiment.

FIG. 3C is a diagram showing the feedback process and data collection in the two direction eye movement test. As shown in FIG. 3C, the transducer 216 collected ultrasound data from the brain 222 of the test subject. The raw data was sampled and beam formed to functional ultrasound images (360). Real-time 2 Hz functional images were streamed to the linear decoder 276 that controlled the behavioral task. The decoder used the last 3 fUS images 362 (1.5 seconds) of the memory period to make a prediction. A task control routine 364 determined whether the prediction was correct based on the action of the test subject. If the prediction was correct, the data from that prediction was added to a training set 370. The decoder 276 was retrained after every successful trial from the training set 370. The training set 370 consisted of images from trials from the current session 372 and/or images from a previous fUS-BMI session 374.

FIG. 3D shows a chart 380 representing a multi-coder algorithm for the eight movement direction task. For predicting eight movement directions, a vertical component 382 includes three positions (up, middle, or down) and a horizontal component 384 includes three positions (left, middle, or right). The vertical and horizontal components 382 and 384 were separately predicted and then combined to form an eight position fUS-BMI prediction 386.

FIG. 3E shows the test process for the memory-guided BMI task. The BMI task is the same as the memory-guided saccade task except that the movement period is controlled by the brain activity (via fUS-BMI) rather than eye movements. A series of eye-movement trials was conducted (390). After 100 successful eye-movement trials, the trained fUS-BMI controlled the movement prediction (closed-loop control) (392). During the closed-loop mode, the NHP test subject had to maintain fixation on the center fixation cue until reward delivery. If the BMI prediction was correct and the NHP test subject held fixation correctly, the NHP test subject received a large liquid reward (1 sec; ˜0.75 mL). If the BMI prediction was incorrect, but the NHP test subject held fixation correctly, the NHP received a smaller liquid reward (100 ms; ˜0.03 mL). In this example, the eye position of the test subject was not visible on the display, but the BMI-controlled cursor position 394 on the display 218 was visible to the test subject.

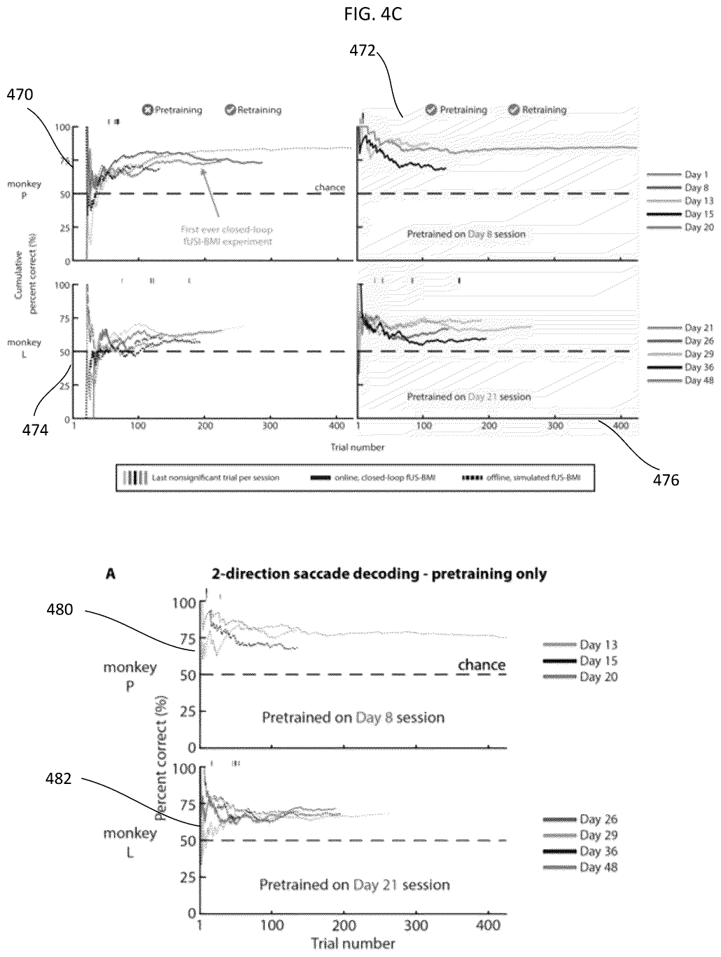

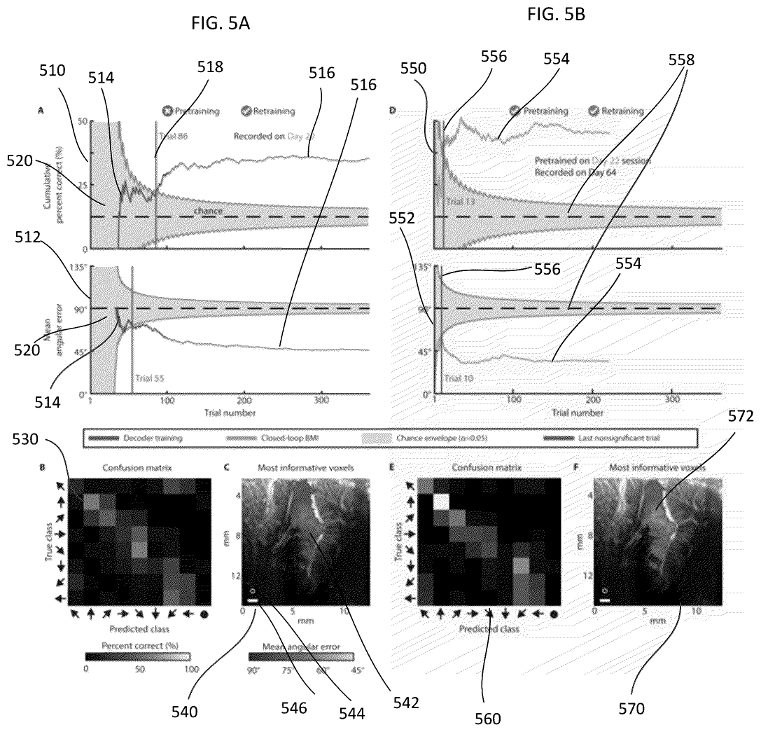

FIG. 4A shows results of the testing for decoding two saccade direction movement task for the test subject monkey P. A graph 410 shows the mean decoding accuracy as a function of the trial number. A trace 412 represents fUS-BMI training where the NHP test subject controlled the task using overt eye movements. The BMI performance shown in the plot 412 was generated post hoc with no impact on the real-time behavior. A trace 414 represents trials under fUS-BMI control where the monkey test subject maintained fixation on the center cue and the movement direction was controlled by the fUS-BMI. A shaded area 416 represents the chance envelope—95% binomial distribution. A line 418 represents the last nonsignificant trial.

FIG. 4A also shows a confusion matrix 420 of decoding accuracy across entire session represented as percentage (rows add to 100%). An ultrasound image 430 shows a shaded area 432 that shows the most informative voxels when performing the task. The ultrasound image 430 is a result of searchlight analysis represents the 10% voxels with the highest decoding accuracy in the shaded area 432 (threshold is q<=1.66e-6). A circle 434 represents the 200 μm searchlight radius used. A bar 436 is a 1 mm scale bar.

FIG. 4B shows results of the testing for decoding two saccade direction movement task for the test subject monkey P where the fUS-BMI decoder was pretrained using data collected from a previous session. In this example, the previous session was conducted on day 8, while the testing occurred in a session on day 20. A graph 440 shows the mean decoding accuracy as a function of the trial number. A trace 442 represents the BMI performance generated post hoc with no impact on the real-time behavior. The trace 442 represents trials under fUS-BMI control where the monkey maintained fixation on the center cue and the movement direction was controlled by the fUS-BMI. A shaded area 446 represents the chance envelope—95% binomial distribution. A line 448 represents the last nonsignificant trial, which is much more recent with the pretraining than that in the graph 410 in FIG. 4A.

FIG. 4B also shows a confusion matrix 450 of decoding accuracy across entire session represented as percentage (rows add to 100%). An ultrasound image 460 shows a shaded area 462 that shows the most informative voxels when performing the task. The ultrasound image 460 is a result of searchlight analysis represents the 10% voxels with the highest decoding accuracy in the shaded area 432 (corresponding to a threshold of q<=2.07e-13.). A circle 464 represents the 200 μm searchlight radius used.

FIG. 4C shows a series of graphs 470, 472, 474, and 476 that show performance across sessions for decoding two saccade directions for the two test subject monkeys. The graphs 470, 472, 474, and 476 shows mean decoder accuracy during each session for monkey P (graphs 470 and 472) and monkey L (graphs 474 and 476). In the graphs 470, 472, 474, and 476, the solid lines are real-time results while fine-dashed lines are simulated sessions from post hoc analysis of real-time fUS imaging data. Vertical marks above each plot represent the last nonsignificant trial for each session. The day number is relative to the first fUS-BMI experiment. The coarse-dashed horizontal black line in each of the graphs 470, 472, 474, and 476 represents chance performance.

The graph 470 represents the sessions conducted on days 1, 8, 13, 15, and 20 for the monkey P using the closed-loop BMI decoder. The graph 472 represents the results from days 13, 15, and 20 for the monkey P using pre-training data from the session on day 8. The graph 474 represents the results of the sessions conducted on days 21, 26, 29, 36, and 40 for the monkey L. The graph 476 represents the results of the sessions conducted on days 29, 36, and 40 based on pre-training data from the session on day 21.

After building a preliminary training set of 20 trials for the two direction task, the accuracy of the decoder 276 was tested on each new trial in a training mode not visible to the NHP test subject. This accuracy is plotted as the plot 412 in the graph 410 in FIG. 4A. After 100 trials, the BMI was switched from training to closed-loop decoding where the NHP test subject now controlled the task direction using his movement intention. The movement intention was determined via brain activity detected by the fUS-BMI decoder 276 in the last 3 fUS images of the memory period. The accuracy was shown by the plot 414 in the graph 410. At the conclusion of each trial, the NHP test subject received visual feedback of the fUS-BMI prediction. In the second closed-loop 2-direction session, the decoder reached significant accuracy (p<0.01; 1-sided binomial test) after 55 training trials and improved in accuracy until peaking at 82% accuracy at trial 114 as shown in the graph 410. The example decoder 276 predicted both directions well above chance level, but displayed better performance for rightward movements as shown in the confusion matrix 420. To understand which brain regions were most important for the decoder performance, the searchlight analysis with a 200 μm, i.e., 2 voxel, radius was performed to produce the image 430. The Dorsal LIP and Area 7a of the brain 222 contained the voxels most informative for decoding intended movement direction.

An ideal BMI needs very little training data and no retraining between sessions. Known electrode-based BMIs generally are quick to train on a given day but need to be retrained on new data for each new session due to their inability to record from the same neurons across multiple days. Due to a wide field of view, fUS neuroimaging can image from the same brain regions over time, and therefore is a desirable technique for stable decoding across many sessions. This was shown by retraining the fUS-BMI decoder 276 using previously recorded session data. The decoder was then tested in an online experiment as explained above. To perform this pretraining, the data from imaging plane of the previous session was aligned to the imaging plane of the current session as shown in FIG. 8. An image 810 from a day 1 session was added to an image 812 from a day 64 session. The images 810 and 812 were overlaid to produce a pre-registration alignment image 820. Rigid-body registration was applied to produce an image 822 of post-registration alignment.

Semi-automated intensity-based rigid-body registration was used to find the transform from the previous session to the new imaging plane. The registration error is shown in the overlay image 820 where a shaded area 830 represents the old session (Day 1) and a shaded area 832 represents the new session (Day 64). This 2D image transform was applied to each frame of the previous session, and the aligned data was saved. This semi-automated pre-registration process took less than 1 minute. To pretrain the model, the fUS-BMI computer 212 automatically loaded this aligned dataset and trained the initial decoder. The fUS-BMI reached significant performance substantially faster as shown by the graph 440 in FIG. 4B when pretraining was applied. The fUS-BMI achieved significant accuracy at trial 7, approximately 15 minutes faster than the example session without pretraining.

To quantify the benefits of pretraining upon fUS-BMI training time and performance, the fUS-BMI performance across all sessions was compared when (a) using only data from the current session versus (b) pretraining with data from a previous session. For all real-time sessions that used pretraining, a post hoc (offline) simulation of the fUS-BMI results without using pretraining was created. For each simulated session, the recorded data was passed through the same classification algorithm used for the real-time fUSI-BMI but did not use any data from a previous session.

A series of tests were performed using only data from the current session to assess the effectiveness of the pre-trained training set. In these tests, the mean decoding accuracy reached significance (p<0.01; 1-sided binomial test) at the end of each online, closed-loop recording session (2/2 sessions monkey P, 1/1 session monkey L) and most offline, simulated recording sessions (3/3 sessions monkey P, 3/4 sessions monkey L) as shown in the graphs in FIG. 4C. For monkey P, decoder accuracies reached 75.43±2.56% (mean±SEM) and took 40.20±2.76 trials to reach significance. For monkey L, decoder accuracies reached 62.30±2.32% and took 103.40±23.63 trials to reach significance.

A series of tests were performed for pretraining with data from a previous session. In these tests, the mean decoding accuracy reached significance at the end of each online, closed-loop recording session (3/3 sessions monkey P, 4/4 session monkey L) as shown in the graph 440 in FIG. 3B. Using previous data reduced the time to achieve significant performance (100% of sessions reached significance sooner, monkey P—36-43 trials faster; monkey L—15-118 trials faster). The performance at the end of the session was not statistically different from performance in the same sessions without pretraining (paired t-test, p<0.05). For monkey P, accuracies reached 80.21±5.61% and took 9.00±1 trials to reach significance. For monkey L, accuracies reached 66.78±2.79% and took 71.00±28.93 trials to reach significance. Assuming no missed trials, pre-training decoders shortened training by 10-45 minutes. The effects of not using any training data from the current session, i.e., using only the pretrained model was also simulated as shown in the graphs 480 and 482. The graph 480 shows the accuracy results of closed-loop, real-time decoding of movement directions using a pretrained model (based on day 8) only for the monkey P for sessions on days 13, 15, and 20. The graph 482 shows the accuracy results of closed-loop, real-time decoding of movement directions using a pretrained model (based on day 21) only for the monkey L for sessions on days 26, 28, 36, and 48. There was no statistical difference between the pretrained models with current session training data and without current session training data for accuracy or number of trials to significance for either NHP test subject for the performance of two direction saccade decoding using only the pretrained model.

These results show that two directions of movement intention may be decoded on line. The NHP test subjects could control the task using the example fUS-BMI. Pretraining using data from a previous session data greatly reduced, or even eliminated, the amount of new training data required in a new session.

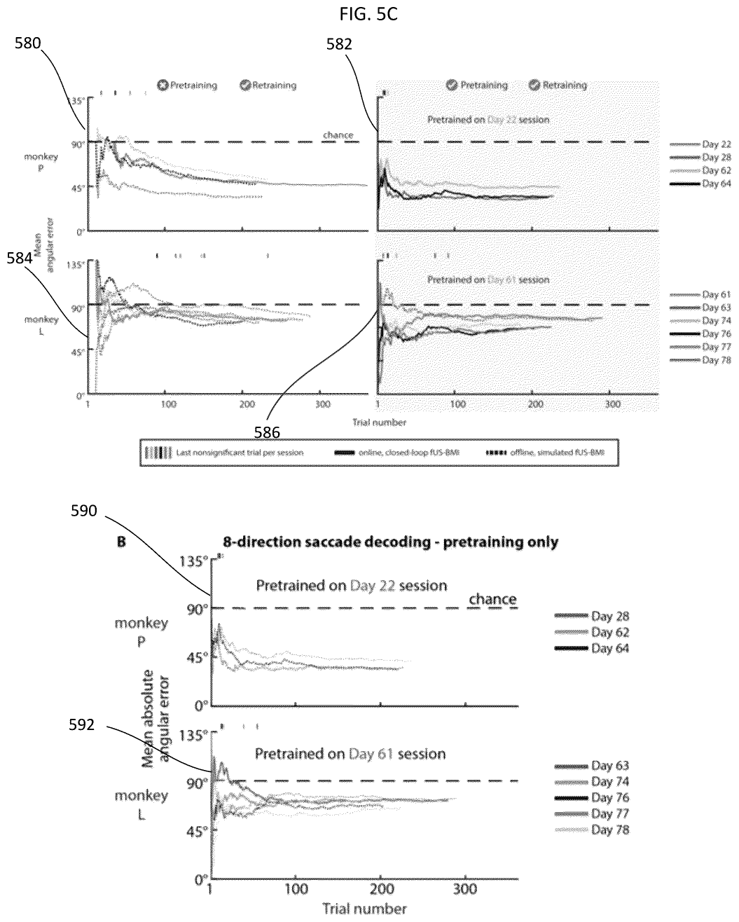

FIG. 5A shows results from example sessions testing the decoding of eight saccade directions. A graph 510 shows the mean decoding accuracy as a function of the trial number and a graph 512 shows the mean absolute angular error as a function of trial number. A plot 514 represents fUS-BMI training where the NHP test subject controlled the task using overt eye movements. The BMI performance shown here was generated post hoc tested on each new trial with no impact on the real-time behavior. A plot 516 represents trials under fUS-BMI control where the NHP test subject maintained fixation on the center cue and the movement task direction was controlled by the fUS-BMI. A line 518 represents the last non-significant trial. A shaded area 520 represents 90% binomial or permutation test distribution.

FIG. 5A also shows a confusion matrix 530 of final decoding accuracy across an entire session represented as percentage (rows add to 100%). The horizontal axis plots the predicted movement (predicted class) and the vertical axis the matching directional cue (true class). An image 540 is a searchlight analysis with an area 542 that represents the 10% of voxels with the lowest mean angular error (threshold is q≤2.98e-3). A circle 544 represents a 200 μm searchlight radius and a bar 546 is a 1 mm scale bar.

FIG. 5B shows the results from tests where the example fUS-BMI was pretrained on data from day 22 and updated after each successful trial. A graph 550 shows the mean decoding accuracy as a function of the trial number and a graph 552 shows the mean absolute angular error as a function of trial number. A plot 554 represents a fUS-BMI that was pretrained on data from a session conducted on day 22 where the NHP test subject maintained fixation on the center cue and the movement task direction was controlled by the fUS-BMI. A line 556 represents the last non-significant trial. A shaded area 558 represents 90% binomial or permutation test distribution.

FIG. 5B also shows a confusion matrix 560 of final decoding accuracy across an entire session represented as percentage (rows add to 100%). The horizontal axis plots the predicted movement (predicted class) and the vertical axis the matching directional cue (true class). An image 570 is a searchlight analysis with an area 572 that represents the 10% of voxels with the lowest mean angular error (threshold is q≤8e-5).

FIG. 5C is shows a series of graphs 580, 582, 584, and 586 that show performance across sessions for decoding eight saccade directions. The graphs 580, 582, 584, and 586 shows mean angular error during each session for monkey P (graphs 580 and 582) and monkey L (graphs 584 and 586). In the graphs 580, 582, 584, and 586, the solid lines are real-time results while the fine-dashed lines are simulated sessions from post hoc analysis of real-time fUS imaging data. Vertical marks above each plot represent the last nonsignificant trial for each session. The day number is relative to the first fUS-BMI experiment. The coarse-dashed horizontal black line in each of the graphs 580, 582, 584, and 586 represents chance performance.

The graph 580 represents the sessions conducted on days 22, 28, 62, and 64 for the monkey P using the closed-loop BMI decoder. The graph 582 represents the results from days 22, 28, 62, and 64 for the monkey P using pre-training from the session on day 22. The graph 584 represents the results of the sessions conducted on days 61, 63, 75, 76, 77, and 78 for the monkey L. The graph 586 represents the results of the sessions conducted on days 61, 63, 75, 76, 77, and 78 for the monkey L based on pre-training from the session on day 61.

The tests conducted for online decoding of eight eye movement directions demonstrate similar performances could be achieved, but online and closed-loop, for a fUS-BMI decoding eight movement directions in real time. A “multicoder” architecture was used where the vertical (up, middle, or down) and horizontal (left, middle, or right) components of intended movement were predicted separately and then combined those independent predictions to form a final prediction (e.g., up and to the right) as shown in the test set up in FIG. 3B. In the first 8-direction experiment, the decoder reached significant accuracy (p<0.01; 1-sided binomial test) after 86 training trials and improved until plateauing at 34-37% accuracy as shown in the graph 510 in FIG. 5A, compared to 12.5% chance level, with most errors indicating directions neighboring the cued direction as shown in the confusion matrix 530. To capture this extra information about proximity of each prediction to the true direction, the mean absolute angular error was examined. The fUS-BMI reached significance at 55 trials and steadily decreased the mean absolute angular error to 45° by the end of the session as shown in the graph 512. Compared to the most informative voxels for the 2-target eye decoder, a larger portion of the LIP, including the ventral LIP, contained the most informative voxels for decoding eight directions of movement as shown in the image 540.

Tests were conducted to determine whether pretraining would aid the 8-target decoding similar to pretraining the 2-target decoder. As before, pretraining reduced the number of trials required to reach significant decoding as shown in the graphs 550 and 552 in FIG. 5B. The fUS-BMI reached significant accuracy at trial 13, approximately 25 minutes earlier than using only data from the current session for training as shown in the graph 550. The mean decoder accuracy reached 45% correct with a final mean absolute angular error of 34°, which was better than the performance achieved in the example session without pretraining. The searchlight analysis indicated the same regions within the LIP provided the most informative voxels for decoding as shown in the image 570 for both the example sessions with and without pretraining. Notably, the fUS-BMI was pretrained on data from 42 days before the current session. This demonstrates that the fUS-BMI can remain stable over at least 42 days. This further demonstrates that the same imaging plane may be consistently located and that mesoscopic PPC populations consistently encode for the same directions on the time span of more than a month.

Tests were conducted using only data from the current session as shown in the graphs 510 and 512 in FIG. 5A. The mean decoder accuracy reached significance by the end of all real-time (2/2) and simulated sessions (8/8). The mean absolute angular error for monkey P reached 45.26±3.44° and the fUS-BMI took 30.75±12.11 trials to reach significance. The mean absolute angular error for monkey L reached 75.06±1.15° and the fUS-BMI took 132.33±20.33 trials to reach significance.

The results from pretraining with data from a previous session were shown in the graphs 582 and 586 in FIG. 5C. The mean decoder accuracy reached significance by the end of all real-time (6/6) and simulated sessions (2/2). The fUS-BMI reached significant decoding earlier for most sessions compared to simulated post hoc data; 5/5 faster monkey L; 2/3 faster monkey P (third session reached significance equally fast). For monkey P, the pretrained decoders reached significance 0-51 trials faster and for monkey L, the pretrained decoders reached significance 66-132 trials faster. For most sessions, this shortened training by up to 45 minutes. The performance at the end of each session was not statistically different from performance in the same session without pretraining (paired t-test, p<0.05). The mean absolute angular error for monkey P reached 37.82°±2.86° and the fUS-BMI took 10.67±1.76 trials to reach significance. The mean absolute angular error for monkey L reached 71.04°±2.29° and the fUS-BMI took 42.80±17.05 trials to reach significance.

The effects of not using any training data from the current session, i.e., using only the pretrained model was also simulated as shown in the graphs 590 and 592 in FIG. 5C. The graph 590 shows the accuracy results of closed-loop, real-time decoding of movement directions using a pretrained model (based on day 22) only for the monkey P for sessions on days 28, 62, and 64. The graph 592 shows the accuracy results of closed-loop, real-time decoding of movement directions using a pretrained model (based on day 61) only for the monkey L for sessions on days 63, 74, 76, 77, and 78. There was no statistical difference between the pretrained models with and without current session training data for accuracy, mean absolute angular error, or number of trials to significance for either NHP test subject performing the 8-direction saccade task.

These results show that eight directions of movement intention may be decoded in real-time at well above chance level. This demonstrates that the example online, closed-loop fUS-BMI system is sensitive enough to detect more than differences between contra- and ipsilateral movements. The directional encoding within PPC mesoscopic populations is stable across more than a month, allowing the reduction or even elimination of the need for new training data.

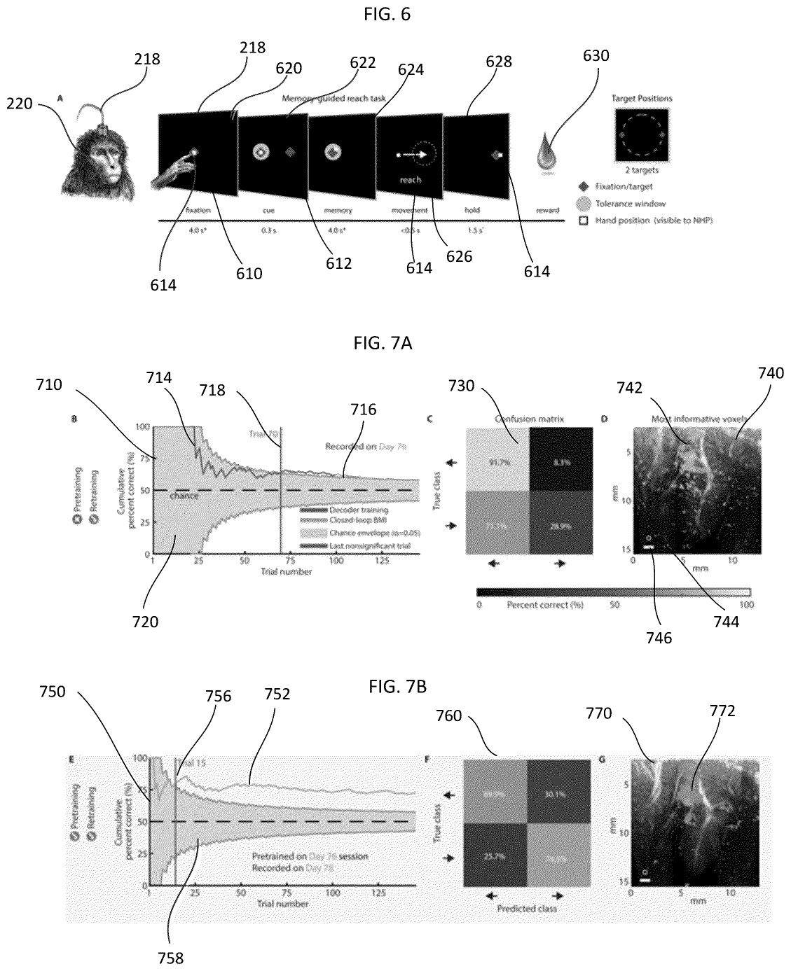

Another strength of fUS neuroimaging is its wide field of view capable of sensing activity from multiple functionally diverse brain regions, including those that encode different movement effectors, e.g., hand and eye. To test this, intended hand movements to two target directions (reaches to the left or right for monkey P) were decoded in addition to the previous results decoding eye movements as explained in relation to the testing process in FIG. 6. FIG. 6 shows a memory-guided two direction reach task for the test subject 220 with the implanted transducer 216. The NHP test subject 220 performed a similar task where the test subject had to maintain touch on a center dot and touch the peripheral targets during the training. In this scenario, hand movements were recorded to train the fUS-BMI system. After the training period, the test subject monkey controlled the task using the fUS-BMI system while keeping his hand on the center fixation cue.

In this test, the monkey P served as the test subject 220. The set up for the memory-guided reach task is identical to the memory-guided saccade task shown in FIG. 3B with all fixation or eye movements being replaced by maintaining touch on the screen 218 and reach movements respectively. After the training period, the monkey test subject 220 controlled the task using the fUS-BMI while keeping his hand on a center fixation cue 610 (620). The same imaging plane was used for eye movement decoding, which contained both LIP (important for eye movements) and MIP (important for reach movements). A target cue 612 was flashed in a peripheral location (622). During a memory period (624), the test subject 220 continued to fixate on the center cue 610 and planned hand movement to the peripheral target location. Once the fixation cue was extinguished, the NHP test subject 220 moved the hand to the remembered location (626) and held the hand on the peripheral location (628) before receiving a liquid reward (630). A square 614 represents the hand position and is visible to the monkey.

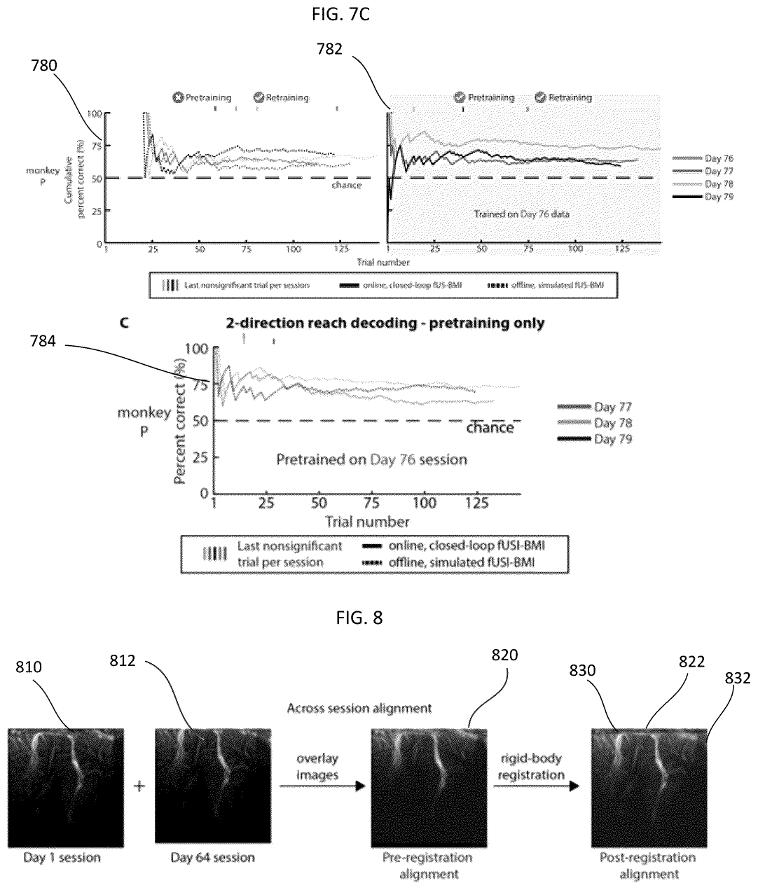

FIG. 7A shows results from example sessions decoding the two direction reach task test shown in FIG. 6. A graph 710 shows the decoding accuracy as a function of the trial number. A plot 714 represents fUS-BMI training where the NHP test subject controlled the task using overt hand movements. The BMI performance shown here was generated post hoc tested on each new trial with no impact on the real-time behavior. A plot 716 represents trials under fUS-BMI control where the NHP test subject maintained fixation on the center cue and the movement task direction was controlled by the fUS-BMI. A line 718 represents the last non-significant trial. A shaded area 720 represents 90% binomial or permutation test distribution.

FIG. 7A also shows a confusion matrix 730 of final decoding accuracy across an entire session represented as percentage (rows add to 100%). The horizontal axis plots the predicted movement (predicted class) and the vertical axis the matching directional cue (true class). An image 740 is a searchlight analysis with areas 742 that represents the 10% of voxels with the lowest mean angular error (threshold is q≤3.05e-3). A circle 744 represents a 200 μm searchlight radius and a bar 746 is a 1 mm scale bar.

In the example session using only data from the current session shown in FIG. 7A, it took 70 trials to reach significance and achieved a mean decoder accuracy of 61.3%. The decoder predominately guessed left as shown in the confusion matrix 730. Two foci within the dorsal LIP and scattered voxels throughout Area 7a and the temporo-parietal junction (Area Tpt) contained the most informative voxels for decoding the two movement directions as shown in the image 740.

FIG. 7B shows the results from tests where the example fUS-BMI was pretrained on data from day 76 and updated after each successful trial. A graph 750 shows the decoding accuracy as a function of the trial number. A plot 752 represents fUS-BMI that was pretrained on data from a session conducted on day 76 where the NHP test subject maintained fixation on the center cue and the movement task direction was controlled by the fUS-BMI. A line 756 represents the last non-significant trial. A shaded area 758 represents 90% binomial or permutation test distribution.

FIG. 7B also shows a confusion matrix 760 of final decoding accuracy across an entire session represented as percentage (rows add to 100%). The horizontal axis plots the predicted movement (predicted class) and the vertical axis the matching directional cue (true class). An image 770 is a searchlight analysis with an area 772 that represents the 10% of voxels with the lowest mean angular error (threshold is q≤6.47e-5).

As with the saccade decoders, pretraining of the movement decoder significantly shortened training time. In some cases, pretraining rescued a “bad” model. For example, the example session using only current data as shown in the confusion matrix 730 in FIG. 7A displayed a heavy bias towards the left. When this example session was used to pretrain the fUS-BMI a few days later, the new model made balanced predictions as shown in the confusion matrix 760. The searchlight analysis for this example session revealed that the same dorsal LIP region from the example session without pretraining contained the majority of the most informative voxels as shown in the image 770. MIP and Area 5 also contained a few patches of highly informative voxels.

FIG. 7C shows a graph 780 of the cumulative percentage correct for the monkey P for sessions conducted on days 76, 77, 78 and 79. A graph 782 shows the cumulative percentage correct for monkey P for sessions based on pretraining from day 76 day. In the graphs 780 and 782, the solid lines are real-time results while fine-dashed lines are simulated sessions from post hoc analysis of real-time fUS imaging data. Vertical marks above each plot represent the last nonsignificant trial for each session. The day number is relative to the first fUS-BMI experiment. The coarse-dashed horizontal line in the graphs 780 and 782 represents chance performance.

Using only data from the current session as shown in the graph 780, the mean decoder accuracy reached significance by the end of each session (1 real-time and 3 simulated) as shown in the plots in the graph 780. The performance reached 65±2% and took 67.67±18.77 trials to reach significance.

When testing pretraining with data from a previous session as shown in the graph 782, the mean decoder accuracy reached significance by the end of each session (3 real-time). The performance of the monkey P reached 65±4% and took 43.67±17.37 trials to reach significance. For two of the three real-time sessions, the number of trials needed to reach significance decreased with pretraining (−2-46 trials faster; 0-16 minutes faster). There was no statistical difference in performance between the sessions with and without pretraining (paired t-test, p<0.05). The effects of not using any training data from the current session, i.e., using only the pretrained model were also studied. A graph 784 shows the percentage correct for monkey P for sessions conducted on days 77, 78, and 79 using only the pre-trained model. There was no statistical difference between the pretrained models with and without current session training data for accuracy or number of trials to significance.

These results agree with the previous results that not only eye movements may be decoded, but also reach movements may be decoded. As with the eye movement decoders, the fUS-BMI may be retrained using data from a previous session reduce, or even eliminate, the need for new training data.

Additional tests were performed to determine whether mesoscopic regions of PPC subpopulations that were robustly tuned to individual movement directions were stable across time. Data was collected from the same coronal plane from two NHP test subjects across many months performing the eight direction memory guided saccade task described above. The example BMI decoder was trained on data from a previous session. The BMI decoder was tested on the ability to predict movement direction on other sessions from that same plane without any retraining of the decoder. The analysis was repeated using each session as the training set and testing all the other sessions.

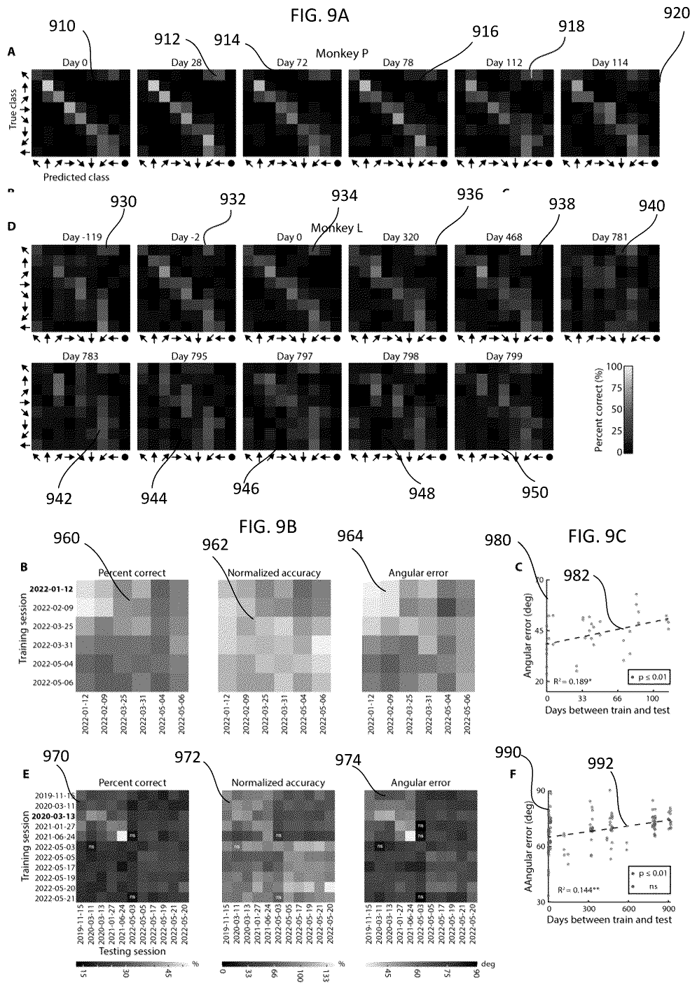

FIG. 9A shows a set of confusion matrices 910, 912, 914, 916, 918, and 920 for test sessions from respective day 0, day 28, day 72, day 78, day 112, and day 114 for the test subject, Monkey P. FIG. 9A also shows a set of confusion matrices 930, 932, 934, 936, 938, 940, 942, 944, 946, 948, and 950 for test sessions from respective day −119, day −2, day 0, day 328, day 468, day 781, day 783, day 795, day 797, day 798, and day 799 for the test subject, Monkey L.

FIG. 9B shows a graph 960 that shows the percentage correct based on the training session data from the session conducted on Jan. 12, 2022 in comparison with subsequent sessions for the test subject, Monkey P. A graph 962 shows the normalized accuracy based on the training session data from the session conducted on Jan. 12, 2022 in comparison with subsequent sessions for the test subject, Monkey P. A graph 964 shows the angular error based on the training session data from the session conducted on Jan. 12, 2022 in comparison with subsequent sessions for the test subject, Monkey P. A graph 970 shows the percentage correct based on the training session data from the session conducted on Mar. 13, 2020 in comparison with other sessions for the test subject, Monkey L. A graph 972 shows the normalized accuracy based on the training session data from the session conducted on Mar. 13, 2020 in comparison with other sessions for the test subject, Monkey L. A graph 974 shows the angular error based on the training session data from the session conducted on Mar. 13, 2020 in comparison with other sessions for the test subject, Monkey L. The graphs 960, 962, 964, 970, 972, and 974 show decoder stability for training and testing on each session. The nonsignificant decoding performance, a was 0.01.

FIG. 9C shows a graph 980 plotting mean angular error as a function of days between the training and testing session for the test subject, Monkey P. A dashed line 982 represents a linear fit to data where *=p<10⁻², and **=p<10⁻⁴ with a R² value of 0.189. A graph 990 plots mean angular error as a function of days between the training and testing session for the test subject, Monkey L. A dashed line 992 represents a linear fit to data where *=p<10⁻², and **=p<10⁻⁴ with a R² value of 0.144. The R² value, or the coefficient of determination, is a measure between 0 and 1 of how well the linear fit models the data. The positive value of R² suggests there is a weak relationship between decoder performance and amount of time since the training session.

For Monkey P, the decoder performance remained significant even after more than 100 days between the training and testing sessions. All pairs of training and testing session for Monkey P showed significant decoding performance (p<10-5; 36/36 pairs) as shown by the graphs 960, 962, and 964. For Monkey L, the decoder performance remained significant across more than 900 days. Almost all pairs of training and testing session for Monkey L showed significant decoding performance (p<0.01; 117/121 pairs) as shown by the graphs 970, 972, and 974. Different training sessions had different decoding performance when tested on itself using cross-validation (diagonal of performance matrices), so w, the accuracy normalized to the training session's cross-validated accuracy, was examined. No clear differences between the absolute and normalized accuracy measures were observed. For Monkey L, the decoder trained on the Mar. 13, 2021 session performed the best for three directions (contralateral up, contralateral down, and ipsilateral down) in the training set and continued to decode these same three directions the best consistently throughout the test sessions as shown in the confusion matrices 930, 932, 934, 936, 938, 940, 942, 944, 946, 948, and 950. This pattern was observed consistently where the decoder could best predict certain directions, even when the training session had poor cross-validated performance by itself.

In both monkeys, temporally adjacent sessions had better performance as shown in the graphs 980 and 990. For Monkey L, the performance was clumped into two temporal groups (before and after May 3, 2023) where training on a session within its same temporal group provided the best performance. Physical changes in the imaging plane across time may explain the decrease in performance. There were out-of-plane alignment issues where the major blood vessels were very similar but mesovasculature would change. This out-of-plane difference was <400 μm across all recording sessions based upon comparing the fUSI imaging planes with anatomical MRIs of the brains of the test subjects. The results demonstrate that a decoder trained from data from a previous session could be used to successfully perform the task in a session occurring at least 900 days from the previous session.

To determine whether differences in vascular anatomy led to the decrease in decoder performance, the similarity of the vascular anatomy across time was examined using an image similarity metric, the complex-wavelet structural similarity index measure (CW-SSIM).

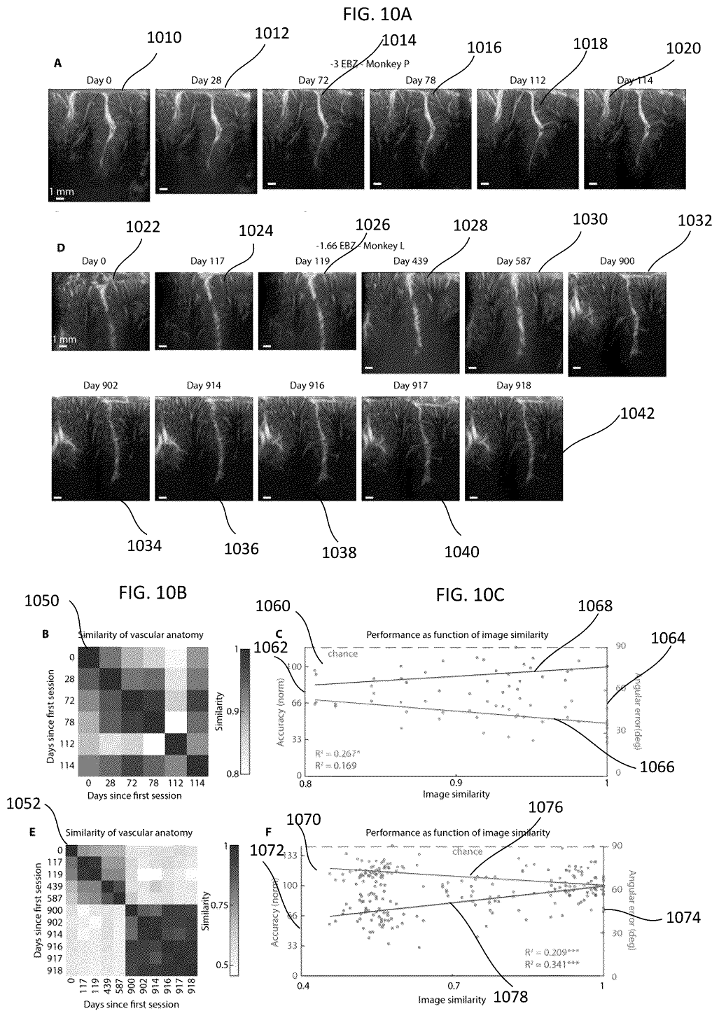

FIG. 10A shows images 1010, 1012, 1014, 1016, 1018, and 1020 of vascular anatomy for each recording session from the same recording slot in Monkey P. The images 1010, 1012, 1014, 1016, 1018, and 1020 are from respective day 0, day 28, day 72, day 78, day 112, and day 114 for Monkey P. Similarly, images 1022, 1024, 1026, 1028, 1030, 1032, 1034, 1036, 1038, 1040, and 1042 of vascular anatomy are from respective day 0, day 117, day 119, day 439, day 587, day 900, day 902, day 914, day 916, day 917, and day 918 for Monkey L. The images in FIG. 10A show that there are differences in vascular anatomy over different sessions.

FIG. 10B shows a chart 1050 of pair-wise similarity between different vascular images for Monkey P for days since the first session. FIG. 10B also shows a chart 1052 of pair-wise similarity between different vascular images for Monkey P for days since the first session.

FIG. 10C shows a graph 1060 showing performance as a function of image similarity for Monkey P. A left axis 1062 shows normalized accuracy. A right axis 1064 shows mean angular error. Each session is represented by a pair of blue and orange dots. A plot 1066 represents the linear fitted model between image similarity (measured by CW-SSIM) and angular error (axis 1062) with an R² of 0.169. A plot 1068 represents the linear fitted model between image similarity (measured by CW-SSIM) and normalized accuracy (axis 1062) with an R² of 0.267. Similarly, a graph 1070 shows performance as a function of image similarity for Monkey L. A left axis 1072 shows normalized accuracy. A right axis 1074 shows mean angular error. Each session is represented by a pair of blue and orange dots. The blue dots represent normalized accuracy (axis 1072). The orange dots represent the angular error (axis 1074). A plot 1076 represents the linear fitted model between image similarity (measured by CW-SSIM) and angular error (axis 1074) with an R² of 341. A plot 1078 represents the linear fitted model between image similarity (measured by CW-SSIM) and normalized accuracy (axis 1072) with an R² of 209. *=p<10-2, **=p<10-4, ***=p<10-6, where this represents the statistical significance of the linear fit. Together, plots 1068 and 1078 show that training and testing sessions that have higher image similarity have improved normalized accuracy. Similarly, plots 1066 and 1076 show that training and testing sessions have higher image similarity have reduced angular error.

The CW-SSIM clumps the vascular images into discrete groups matching the qualitative assessment of image similarity as shown in FIG. 10B that matched qualitative assessment of image similarity. The similarity grouping also matched the pairwise decoding performance grouping in Monkey L as shown in the graphs 970, 972, and 974. The decoder performance and image similarity were correlated as shown in FIG. 10C. As image similarity decreased between the training session and each test session, the decoder performance also decreased. This shows that the decrease in decoder performance resulted from changes in the imaging plane rather than drift in the tuning of each subpopulation.

The example closed-loop, online, ultrasonic BMI system and method may be applied to a next generation of minimally-invasive ultrasonic BMIs via the ability to decode more movement directions and stabilize decoders across more than a month.

The decoding of more movement directions was shown in the successful decoding of eight movement directions in real-time. Specifically, the two direction results were replicated using real-time online data and extended to the decoder to work for eight movement directions.

The stabilizing of the decoder across time was shown by electrode-based BMIs that are particularly adept at sensing fast changing (˜10s of ms) neural activity from spatially localized regions (<1 cm) during behavior or stimulation that is correlated to activity in such spatially specific regions, e.g., M1 for motor and V1 for vision. Electrodes, however, suffer from an inability to track individual neurons across recording sessions. Consequently, decoders based on data from electrodes are typically retrained each day. In the example system image-based BMIs were stabilized across more than a month and decode from the same neural populations with minimal, if any, retraining. This is a critical development that enables easy alignment of models from previous days to data from a new day. This allows decoding to begin while acquiring minimal to no new training data. Much effort has focused on reducing or eliminating re-training in electrode-based BMIs. However, these methods require identification of manifolds and/or latent dynamical parameters and collecting new data to align to these manifolds/parameters. Furthermore, some of the algorithms are not yet optimized for online use and/or are computationally expensive and difficult to implement. The example pre-trained decoder alignment algorithm leverages the intrinsic spatial resolution and field of view provided by fUS neuroimaging to simplify this process in a way that is intuitive, repeatable, and performant.

The present system may be improved in several ways. First, realigning the recording chamber and ultrasound transducer along the intraparietal sulcus axis would allow sampling from a larger portion of LIP and MIP. In the tests described herein, the chamber and probe were placed in a coronal orientation to aid anatomical interpretability. However, most of the imaging plane is not contributing to the decoder performance in these tests. Receptive fields are anatomically organized along anterior-posterior and dorsal-ventral gradients within LIP25. By realigning the recording chamber orthogonal to the intraparietal sulcus, sampling may be performed from a larger anterior-posterior portion of LIP with diverse range of directional tunings.

Second, the advent of 3D ultrafast volumetric imaging based on matrix or row-column array technologies will be capable of sensing changes in CBV from blood vessels that are currently orthogonal to the imaging plane. Additionally, 3D volumetric imaging can fully capture entire functional regions and sense multiple functional regions simultaneously. There are many regions which could fit inside a field of view of a 3D probe and contribute to a motor BMI, for example: PPC, primary motor cortex (M1), dorsal premotor cortex (PMd), and supplementary motor area (SMA). These areas encode different aspects of movements including goals, sequences, and expected value of actions. This is just one example of myriad advanced BMI decoding strategies that will be made possible by synchronous data across brain regions.

Third, another route for improved performance is using more advanced decoder models. In the example herein, linear discriminant analysis was used to classify the intended target of the NHP test subjects. Artificial neural networks (ANNs) are an option. For example, convolutional neural networks are tailor-made for identifying image characteristics. Recurrent neural networks and transformers use “memory” processes and may be particularly adept at characterizing the temporal structure of fUS time series data. A potential downside of ANNs is that they require significantly more data than the linear method presented here. However, the example methods for across session image alignment will allow for already-collected data to be aggregated and organized into a large data corpus. Such a data corpus should be sufficient for small to moderately sized ANNs. The amount of training data required may be further reduced by decreasing the feature counts of the ANNs. For example, the input layer dimensions may be reduced by restricting the image to features collected only from the task-relevant areas, such as LIP and MIP, instead of the entire image. ANNs additionally take longer to train (˜minutes instead of seconds) and require different strategies for online retraining. Due to ANNs taking substantially longer to train, a different strategy of training during the intertrial interval following any addition to the training set is necessary. For example, a parallel computing thread that retrained the ANN every 10-20 trials may be implemented and then the fUS-BMI could retrieve the latest trained model on each trial.

fUS neuroimaging has several advantages compared to existing BMI technologies. The large and deep field of view of fUS neuroimaging allows reliable recording from multiple cortical and subcortical regions simultaneously—and to record from the same populations in a stable manner over long periods of time. fUS neuroimaging is epidural, i.e., does not require penetration of the dura mater, substantially decreasing surgical risk, infection risk, and tissue reactions while enabling chronic imaging over long periods of time (potentially many years) with minimal, if any degradation, in signal quality. In the NHP studies, fUS neuroimaging has been able to image through the dura, including the granulation tissue that forms above the dura (several ˜mm) with minimal loss in sensitivity.

The example fUSI system with a pre-trained decoder is stable across multiple days, months or even years. Using conventional image registration methods, the decoder may be aligned across different recording sessions and achieve excellent performance without collecting additional training data. A weakness of this current fUS-BMI compared to current electrophysiology BMIs is poorer temporal resolution. Electrophysiological BMIs have temporal resolutions in the 10s of milliseconds (e.g., binned spike counts). fUS can reach a similar temporal resolution (up to 500 Hz in this work) but is limited by the time constant of mesoscopic neurovascular coupling (˜seconds). Despite this neurovascular response acting as a low pass filter on each voxel's signal, faster fUS acquisition rates can measure temporal variation across voxels down to <100 ms resolution.

As the temporal resolution and latency of real-time fUS imaging improves with enhanced hardware and software, tracking the propagation of these rapid hemodynamic signals will enable improved BMI performance and response time. Beyond movement, many other signals in the brain may be better suited to the spatial and temporal strengths of fUS, for example, monitoring biomarkers of neuropsychiatric disorders.

As explained above, dorsal and ventral LIP contained the most informative voxels when decoding eye movements. This is consistent with previous findings that the LIP is important for spatially specific oculomotor intention and attention. Dorsal LIP, MIP, Area 5, and Area 7 contained the most informative voxels during reach movements. The voxels within the LIP closely match with the most informative voxels from the 2-direction saccade decoding, suggesting that the example fUS-BMI is using eye movement plans to build its model of movement direction. The patches of highly informative voxels within MIP and Area 5 indicate the example fUS-BMI are using reach-specific information.

The vast majority of BMIs have focused on motor applications, e.g., restoring lost motor function in people with paralysis. Closed-loop BMIs may restore function to other demographics, such as patients disabled from neuropsychiatric disorders. Depression, the most common neuropsychiatric disorder, affects an estimated 3.8% of people (280 million) worldwide. The utility of the fUS-BMI for motor applications allows easier comparison with existing BMI technologies. fUS-BMIs are an ideal platform for applications that require monitoring neural activity over large regions of the brain and long time scales, from hours to months. As demonstrated by the tests, fUS neuroimaging captures neurovascular changes on the order of a second and is also stable over more than 1 month. Combined with neuromodulation techniques such as focused ultrasound, not only these distributed corticolimbic populations may be recorded but also specific mesoscopic populations may be precisely modulated. Thus, the fUS-BMI using the techniques herein may be applied to a broader range of applications, including restoring function to patients suffering from debilitating neuropsychiatric disorders.

The principles in this disclosure may be incorporated in a number of below described implementations.

Implementation 1: A method of determining a brain state for generating a control signal, the method comprising:
sensing brain state data from a brain of a subject via a sensor during a current session;
decoding the image from the brain of the subject to determine a brain state output via a decoder trained from a pre-training data set from a pre-training set of brain state data correlated with performance of a task by the subject at a previous session; and
generating a control signal to perform the task based on the brain state output.

Implementation 2: The method of Implementation 1, wherein the sensor includes a functional ultrasound transducer.

Implementation 3: The method of Implementation 2, wherein the functional ultrasound transducer is positioned for coronal planes of the posterior parietal cortex (PPC) of the brain.

Implementation 4: The method of Implementation 1, further comprising:
recording the brain state data correlated with the performance of the task; and
adding the brain state data correlated with the successful performance of the task by the subject to the pre-training set of recorded brain state data.

Implementation 5: The method of Implementation 1, wherein the brain state output is a kinematics control, the method further comprising providing the control signal to an output interface.

Implementation 6: The method of Implementation 5, wherein the output interface is a display and wherein the control signal manipulates an object on a display.

Implementation 7: The method of Implementation 5, wherein the control signal manipulates
a mechanical actuator.

Implementation 8: The method of Implementation 1, wherein the previous session occurs between 1 and 900 days from the current session.

Implementation 9: The method of Implementation 1, wherein the brain state data are taken from an imaging plane of the brain, and wherein the pre-training includes aligning the brain state data of the pre-training data set to produce a pre-registration alignment image.

Implementation 10: The method of Implementation 1, wherein the pre-training brain state data are images produced by functional magnetic resonance imaging of the brain of the subject.

Implementation 11: The method of Implementation 1, wherein the brain state data input is one of a 2D image or a 3D image.

Implementation 12: The method of Implementation 1 wherein the brain state data input is one of a sequence of images used to decode the brain state.

Implementation 13: The method of Implementation 1, wherein the decoder performs principal component (PCA) and linear discriminant analysis (LDA) to predict movement direction from the brain state data.

Implementation 14: A brain interface system comprising:
a sensor sensing brain state data from a brain of a subject during a current session;
a decoder determining a brain state output from the sensed brain state data, the decoder trained from a pre-training set of brain state data correlated with performance of a task by the subject at a previous session; and
a controller coupled to the decoder to generate a control signal to actuate performance of the task.

Implementation 15: The system of Implementation 14, wherein the sensor includes a functional ultrasound transducer.

Implementation 16: The system of Implementation 15, wherein the functional ultrasound transducer is positioned for coronal planes of the posterior parietal cortex (PPC) of the brain.

Implementation 17: The system of Implementation 14, wherein the controller further: records the brain state data correlated with the performance of the task; and adds the brain state data correlated with the performance of the task by the subject to the pre-training set of recorded brain state data.

Implementation 18: The system of Implementation 14, further comprising an output interface coupled to the controller, wherein the brain state output is a kinematics control, and the control signal is provided to the output interface.

Implementation 19: The system of Implementation 18, wherein the output interface is a display and wherein the control signal manipulates an object on a display.

Implementation 20: The system of Implementation 18, further comprising a mechanical actuator coupled to the output interface, wherein the control signal manipulates the mechanical actuator.

Implementation 21: The system of Implementation 14, wherein time between the training session and the current session is between 1 and 900 days.

Implementation 22: The system of Implementation 14, wherein the brain state data are taken from an imaging plane of the brain, and wherein the pre-training includes aligning the brain state data of the pre-training data set to produce a pre-registration alignment image.

Implementation 23: The system of Implementation 14, wherein the pre-training brain state data are images produced by functional magnetic resonance imaging of the brain of the subject.

Implementation 24: The system of Implementation 14, wherein the brain state data input is one of a 2D image or a 3D image.

Implementation 25: The system of Implementation 14, wherein the brain state data input is one of a sequence of images used to decode the brain state.

Implementation 26: The system of Implementation 14, wherein the decoder module performs principal component (PCA) and linear discriminant analysis (LDA) to predict movement direction from the brain state data.

Implementation 27: A non-transitory computer-readable medium having machine-readable instructions stored thereon, which when executed by a processor, cause the processor to:
sense brain state data from a brain of a subject via a sensor during a current session;
decode the brain state data from the brain of the subject to determine a brain state output via a decoder trained from a pre-training data set trained from a pre-training set of brain state data correlated with performance of a task by the subject at a previous session; and
generate a control signal to perform the task based on the brain state output.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In one or more embodiments, computer-executable instructions are executed on a general purpose computer to turn the general purpose computer into a special purpose computer implementing elements of the disclosure. The computer executable instructions may be, for example, binaries, intermediate format instructions such as assembly language, or even source code. Although the subject matter has been described in language specific to structural marketing features and/or methodological acts, it is to be understood that the subject matter defined in the appended claims is not necessarily limited to the described marketing features or acts described above. Rather, the described marketing features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as an un-subscription model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing un-subscription model can be composed of various characteristics such as, for example, on-demand self-service, broad network access, resource pooling, rapid elasticity, measured service, and so forth. A cloud-computing un-subscription model can also expose various service un-subscription models, such as, for example, Software as a Service (“SaaS”), a web service, Platform as a Service (“PaaS”), and Infrastructure as a Service (“IaaS”). A cloud-computing un-subscription model can also be deployed using different deployment un-subscription models such as private cloud, community cloud, public cloud, hybrid cloud, and so forth. In this description and in the claims, a “cloud-computing environment” is an environment in which cloud computing is employed.

In one example, a computing device may be configured to perform one or more of the processes described above. the computing device can comprise a processor, a memory, a storage device, an I/O interface, and a communication interface, which may be communicatively coupled by way of a communication infrastructure. In certain embodiments, the computing device can include fewer or more components than those described above.

In one or more embodiments, the processor includes hardware for executing instructions, such as those making up a computer program. As an example and not by way of limitation, to execute instructions for digitizing real-world objects, the processor may retrieve (or fetch) the instructions from an internal register, an internal cache, the memory, or the storage device and decode and execute them. The memory may be a volatile or non-volatile memory used for storing data, metadata, and programs for execution by the processor(s). The storage device includes storage, such as a hard disk, flash disk drive, or other digital storage device, for storing data or instructions related to object digitizing processes (e.g., digital scans, digital models).

The I/O interface allows a user to provide input to, receive output from, and otherwise transfer data to and receive data from computing device. The I/O interface may include a mouse, a keypad or a keyboard, a touch screen, a camera, an optical scanner, network interface, modem, other known I/O devices or a combination of such I/O interfaces. The I/O interface may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface is configured to provide graphical data to a display for presentation to a user. The graphical data may be representative of one or more graphical user interfaces and/or any other graphical content as may serve a particular implementation.

The communication interface can include hardware, software, or both. In any event, the communication interface can provide one or more interfaces for communication (such as, for example, packet-based communication) between the computing device and one or more other computing devices or networks. As an example and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI.

Additionally, the communication interface may facilitate communications with various types of wired or wireless networks. The communication interface may also facilitate communications using various communication protocols. The communication infrastructure may also include hardware, software, or both that couples components of the computing device to each other. For example, the communication interface may use one or more networks and/or protocols to enable a plurality of computing devices connected by a particular infrastructure to communicate with each other to perform one or more aspects of the digitizing processes described herein. To illustrate, the image compression process can allow a plurality of devices (e.g., server devices for performing image processing tasks of a large number of images) to exchange information using various communication networks and protocols for exchanging information about a selected workflow and image data for a plurality of images.

It should initially be understood that the disclosure herein may be implemented with any type of hardware and/or software, and may be a pre-programmed general purpose computing device. For example, the system may be implemented using a server, a personal computer, a portable computer, a thin client, or any suitable device or devices. The disclosure and/or components thereof may be a single device at a single location, or multiple devices at a single, or multiple, locations that are connected together using any appropriate communication protocols over any communication medium such as electric cable, fiber optic cable, or in a wireless manner.

It should also be noted that the disclosure is illustrated and discussed herein as having a plurality of modules which perform particular functions. It should be understood that these modules are merely schematically illustrated based on their function for clarity purposes only, and do not necessary represent specific hardware or software. In this regard, these modules may be hardware and/or software implemented to substantially perform the particular functions discussed. Moreover, the modules may be combined together within the disclosure, or divided into additional modules based on the particular function desired. Thus, the disclosure should not be construed to limit the present invention, but merely be understood to illustrate one example implementation thereof.

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a “control system” on data stored on one or more computer-readable storage devices or received from other sources.

The term “control system” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

While various embodiments of the present invention have been described above, it should be understood that they have been presented by way of example only, and not limitation. Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above-described embodiments. Rather, the scope of the invention should be defined in accordance with the following claims and their equivalents.

1. A method of training a brain machine interface system comprising:
conducting an initial session of sensing brain state data of a brain of a subject during performance of a task at a first time;
recording the brain state data correlated with the performance of the task;
assembling a pre-training set of the brain state data correlated with the performance of the task by the subject;
pre-training a decoder module of the brain machine interface system with the pre-training set of the recorded brain state data to decode intentions of the subject correlated with brain state; and
conducting a current session at a second time subsequent to the first time, wherein the current session includes the pre-trained decoder module accepting a brain state data input of the brain of the subject, decoding a brain state output from the brain state data input, and generating a control signal to perform the task based on the determined brain state output.

2. The method of claim 1, wherein the brain state data input of the brain of the subject is obtained via a functional ultrasound transducer coupled to a scanner.

3. The method of claim 2, wherein the functional ultrasound transducer is positioned for the posterior parietal cortex (PPC) of the brain.

4. The method of claim 1, further comprising:
sensing brain state data of the brain of the subject during performance of the task during the current session;
recording the brain state data correlated with the performance of the task; and
adding the brain state data correlated with the performance of the task by the subject to the pre-training set of recorded brain state data.

5. The method of claim 1, wherein the first time is between 1 and 900 days from the second time.

6. The method of claim 1, wherein the brain state data are taken from an imaging plane of the brain, and wherein the pre-training includes aligning the brain state data of the pre-training data set to produce a pre-registration alignment image.

7. The method of claim 1, wherein the pre-training brain state data are images produced by functional magnetic resonance imaging of the brain of the subject.

8. The method of claim 1, wherein the brain state data input is one of a 2D image or a 3D image.

9. The method of claim 1, wherein the brain state data input is one of a sequence of images used to decode the brain state.

10. The method of claim 1, wherein the decoder module performs principal component (PCA) and linear discriminant analysis (LDA) to predict movement direction from the brain state data.

11. A system for training a brain machine interface (BMI), the system comprising:
a training set generation system including a transducer coupled to a brain state data system to sense brain state data of a brain of a subject during performance of a task at a first time;
a storage device storing the brain state data correlated with the performance of the task as a pre-training set of the brain state data correlated with the performance of the task by the subject;
a decoder module of the brain machine interface system trained with the pre-training set of the recorded brain state data to decode movement intentions of the subject correlated with brain state;
a scanner operable to sense brain state data of the brain of the subject;
a BMI coupled to the scanner, the BMI operable to conduct a current session at a second time subsequent to the first time, the BMI including the decoder module accepting a brain state data input of the brain of the subject, decoding a brain state output from the brain state data input, and generating a control signal to perform the task based on the determined brain state output.

12. The system of claim 11, wherein the scanner includes a functional ultrasound transducer.

13. The system of claim 12, wherein the functional ultrasound transducer is positioned for the left posterior parietal cortex (PPC) of the brain.

14. The system of claim 11, wherein the BMI is further operable to: record the brain state data of the brain of the subject correlated with the performance of the task; and add the brain state data correlated with the performance of the task by the subject to the pre-training set of recorded brain state data.

15. The system of claim 11, wherein the first time is between 1 and 900 days from the second time.

16. The system of claim 11, wherein the brain state data are taken from an imaging plane of the brain, and wherein the pre-training includes aligning the brain state data of the pre-training data set to produce a pre-registration alignment image.

17. The system of claim 11, wherein the pre-training brain state data are images produced by functional magnetic resonance imaging of the brain of the subject.

18. The system of claim 11, wherein the brain state data input is one of a 2D image or a 3D image.

19. The system of claim 11, wherein the brain state data input is one of a sequence of images used to decode the brain state.

20. The system of claim 11, wherein the decoder module performs principal component (PCA) and linear discriminant analysis (LDA) to predict movement direction from the brain state data.

21. A non-transitory computer-readable medium having machine-readable instructions stored thereon, which when executed by a processor, cause the processor to:
record brain state data of a brain of a subject correlated with the performance of a task at a first time;
assemble a pre-training set of the brain state data correlated with the performance of the task by the subject;
pre-train a decoder module of the brain machine interface system via the pre-training set of the recorded brain state data to decode intentions of the subject correlated with brain state; and
conduct a current session at a second time subsequent to the first time, wherein the current session includes the decoder module accepting a brain state data input of the brain of the subject, decoding a brain state output from the brain state data input, and generating a control signal to perform the task based on the determined brain state output.
